(19) United States
(12) Patent Application Publication
(10) Pub. No.: US 2025/0139632 A1
(43) Pub. Date: May 1, 2025

(54) SYSTEMS AND METHODS FOR CONTINUOUS EVENT MONITORING, IDENTIFICATION OF RISK SIGNALS, AND ACCELERATION OF FRAUD RISK ANALYSIS

(71) Applicant: The PNC Financial Services Group, Inc., Pittsburgh, PA (US)

(72) Inventors: Jason Ray BUELL, Independence, KY (US); Devon Leon BIERE, Lorain, OH (US); Adam John WECHTER, Pittsburgh, PA (US); Eric Arthur PAETZ, Shaker Heights, OH (US)

(21) Appl. No.: 18/989,434

(22) Filed: Dec. 20, 2024

Related U.S. Application Data
(63) Continuation of application No. 18/609,691, filed on Mar. 19, 2024.
(60) Provisional application No. 63/499,620, filed on May 2, 2023.

(51) Int. Cl. G06Q 20/40; G06F 40/205

(52) U.S. Cl. CPC G06Q 20/4016; G06F 40/205

(57) ABSTRACT

An apparatus and a method are disclosed for analyzing attributes of electronic transactions. The method includes generating a combined standardized transaction data structure based on analysis of transaction data; creating or updating one or more composite risk signals based on analysis of event data; obtaining one or more additional risk signals using machine learning based on at least one of: the combined standardized transaction data structure, the one or more composite risk signals, the event data, or third party data received from a third party data provider; and generating at least one of a detection event, a transaction alert, a case management message or a regulatory filing message based on at least one of: the combined standardized transaction data structure, the one or more composite risk signals, or the one or more additional risk signals obtained by machine learning, or the third party data.

### 1. CROSS-REFERENCE TO RELATED APPLICATION

This application is based on and claims benefit of priority of U.S. Provisional Patent Application No. 63/499,620, filed May 2, 2023, the entire contents of which are incorporated herein by reference.

### 2. TECHNICAL FIELD

The present disclosure relates generally to risk identification, and more particularly, to methods and apparatuses for fraud risk identification in a financial transaction system.

### 3. BACKGROUND

Current systems for handling financial transactions suffer from fraud and crimes that compromise the integrity of the electronic transaction. Current electronic transaction systems have fraud detection techniques, but such techniques are prone to loopholes that have been exploited. Improved systems and methods for detecting fraudulent electronic transactions are desired.

### 4. SUMMARY

According to some embodiments of the present disclosure, there is provided a method for analyzing attributes of electronic transactions. The method may include: generating a combined standardized transaction data structure based on analysis of transaction data; creating or updating one or more composite risk signals based on analysis of event data; obtaining one or more additional risk signals using machine learning based on at least one of: the combined standardized transaction data structure, the one or more composite risk signals, the event data, or third party data received from a third party data provider; and generating at least one of a detection event, a transaction alert, a case management message or a regulatory filing message based on at least one of: the combined standardized transaction data structure, the one or more composite risk signals, or the one or more additional risk signals obtained by machine learning, or the third party data.

According to some embodiments of the present disclosure, there is provided a system for analyzing attributes of electronic transactions. The system may include one or more processors, and one or more memories storing instructions which, when executed by the one or more processors, cause the system to: generate a combined standardized transaction data structure based on analysis of transaction data; create or update one or more composite risk signals based on analysis of event data; obtain one or more additional risk signals using machine learning based on at least one of: the combined standardized transaction data structure, the one or more composite risk signals, the event data, or third party data received from a third party data provider; and generate at least one of a detection event, a transaction alert, a case management message or a regulatory filing message based on at least one of: the combined standardized transaction data structure, the one or more composite risk signals, or the one or more additional risk signals obtained by machine learning, or the third party data.

According to some embodiments of the present disclosure, there are further provided one or more non-transitory computer readable media storing instructions that, when executed by one or more processors, cause the one or more processors to perform a method for analyzing attributes of electronic transactions. The method may include generating a combined standardized transaction data structure based on analysis of transaction data; creating or updating one or more composite risk signals based on analysis of event data; obtaining one or more additional risk signals using machine learning based on at least one of: the combined standardized transaction data structure, the one or more composite risk signals, the event data, or third party data received from a third party data provider; and generating at least one of a detection event, a transaction alert, a case management message or a regulatory filing message based on at least one of: the combined standardized transaction data structure, the one or more composite risk signals, or the one or more additional risk signals obtained by machine learning, or the third party data.

### 5. BRIEF DESCRIPTION OF FIGURES

FIG. 1 shows an example of a low-risk electronic transaction, consistent with some embodiments of the present disclosure.

FIG. 2 shows an example of a high-risk electronic transaction, consistent with some embodiments of the present disclosure.

FIG. 3 is a schematic diagram illustrating vulnerabilities in an electronic transaction system.

FIG. 4 is a block diagram illustrating the structure of a prior art system and its associated drawbacks.

FIG. 5 is a block diagram illustrating a microservice structure consistent with some embodiments of the present disclosure.

FIG. 6 is an exemplary process diagram illustrating a method for fraud risk analysis, consistent with some embodiments of the present disclosure.

FIG. 7 is an exemplary process diagram illustrating a more detailed depiction of the Fraud Detection and Alerting Platform seen in FIG. 6.

FIG. 8 is an exemplary process diagram illustrating a more detailed depiction of the Data Standardization step seen in FIG. 6.

FIG. 9 is a simplified schematic process diagram illustrating a core feedback loop consistent with some embodiments of the present disclosure.

FIG. 10 shows a flowchart of an example method for analyzing attributes of electronic transactions, consistent with some embodiments of the present disclosure.

FIG. 11 is a diagram illustrating an implementation of event driven architecture compared to an exemplary prior art system.

FIG. 12 is a block diagram illustrating some exemplary inputs used in composite risk profiles to generate a composite risk score.

FIG. 13 is a block diagram illustrating a microservice structure, consistent with some embodiments of the present disclosure.

FIG. 14 is a block diagram illustrating the resiliency of a microservice structure.

FIG. 15 is a block diagram illustrating circuit breaker controls, consistent with some embodiments of the present disclosure.

FIG. 16 shows a flowchart of an example method for using circuit breaker controls to reliably send data through microservices, consistent with some embodiments of the present disclosure.

### 6. DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of systems, apparatuses, and methods consistent with aspects related to the present disclosure as recited in the appended claims.

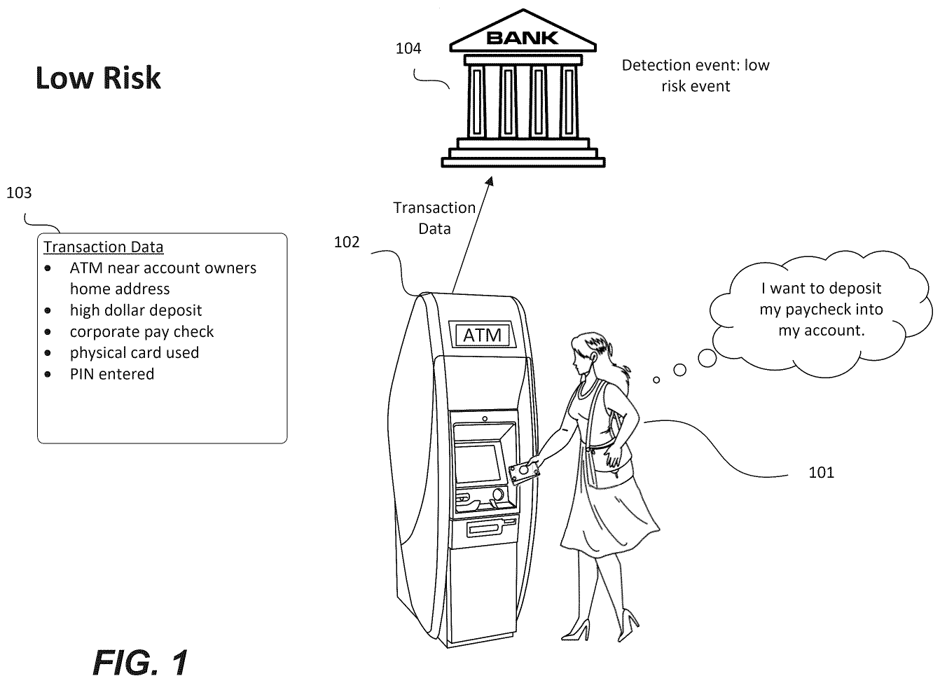

FIG. 1 shows an example of a low-risk electronic transaction, consistent with some embodiments of the present disclosure. Referring to FIG. 1, a user 101 may approach an ATM (automated teller machine) 102 to deposit a paycheck. In this example, the deposit transaction may have various attributes. The transaction data 103 may indicate that paycheck is made out to the account owner, the ATM is located near the account owner's home address, a physical card was used with the ATM and its corresponding personal identification number (PIN), and the deposit may be for a large dollar value. The transaction data 103 may be sent to a bank 104 for fraud risk analysis. The bank 104 may have a composite risk profile for the user's checking out, which includes information such as, the recent login, regular large month paycheck deposits, the age of the account, etc. At least some embodiments of the present application are directed to methods for handling risk signals for a user account. For example, according to the method disclosed in this application, the risk profile and transaction data may be processed for input into a machine learning model, where the algorithm identifies the high dollar value of the deposit as a risk signal, with a low fraud probability score. The processed transaction data, the risk signal, and the composite risk profile may be provided to a commercial fraud detection platform, which outputs a detection event for a low-risk event (e.g., the high deposit value), but takes no other action based on a determination that the overall fraud risk is low based on the totality of the processed data.

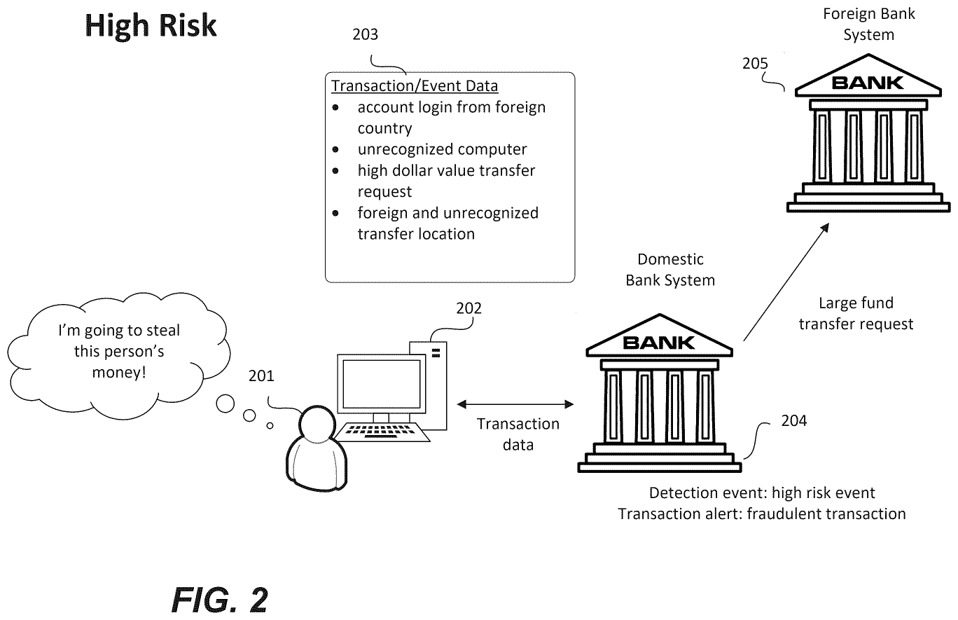

FIG. 2 shows an example of a high-risk electronic transaction, consistent with some embodiments of the present disclosure. Referring to FIG. 2, a user 201 in a foreign country may login to a banking account through a personal computer system 202 using stolen login information. The user 201 may access transaction data of a domestic bank system 204, and may further access a foreign bank system 205 via the domestic bank system 204. The user 201 may then attempt to transfer all of the money in the account of the domestic bank system 204 to the foreign banking system 205. The login and transaction may have certain transaction/event data 203. The transaction/event data 203 may include, for example, an account login from a foreign country, a login from an unrecognized computer, a high dollar value transfer request, a foreign and unrecognized transfer location, etc. The domestic bank system 204 may have a composite risk profile for the account that was logged into, which may contain information such as a lack of two factor authentication, a password that is over a year old, or other data indicating high-risk signals for the account. At least some embodiments of the present application are directed to handling such high-risk signals for a user account. For example, according to the methods of the present disclosure, the risk profile and transaction data may be processed for input into a machine learning model, where the algorithm identifies the high dollar value of the transfer request as a risk signal, with a high fraud probability score. The processed transaction data, the risk signal, and the composite risk profile may be provided to a fraud detection platform. The fraud detection platform outputs a detection event for a high-risk event, and the high-risk event is input into a transaction alert provider so that the transaction alert can provide a transaction alert for the fraudulent activity. The transaction alert provider also provides inputs to a case management provider, and the case management provider provides a case management message detailing the attempted fraud. The case management provider also provides inputs to a regulatory filing provider, and the regulatory filing provider provides a regulatory filing message. The system may take action such as freezing the account, requiring logging with additional security questions, resetting the account password, block the transaction request, etc.

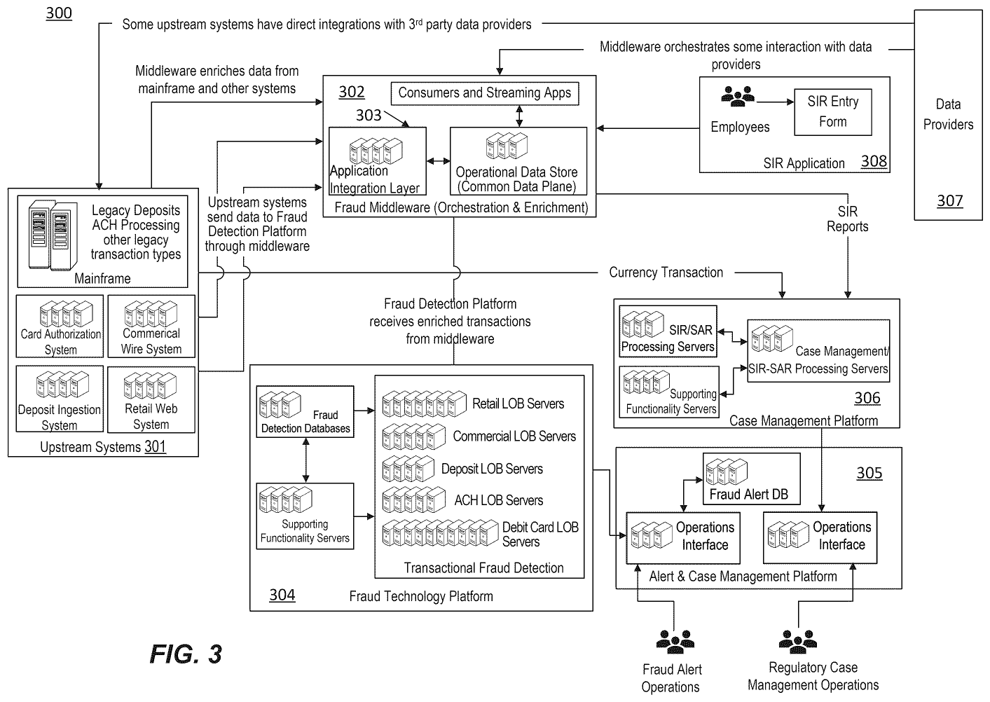

FIG. 3 is a schematic diagram illustrating vulnerabilities in an electronic transaction system 300. Referring to FIG. 3, the fraud and financial crimes ecosystem include a middleware 302, upstream systems 301 that are upstream to the middleware 302, application (App) servers (or application integration layer) 303, and risk investigation tools. FIG. 3 shows that App servers 303 as part of the middleware 302, but the scope of the present application is not so limited. In some embodiments, the App servers 303 may be separated or independent from the middleware 302. The middleware 302 can be software that different applications use to communicate with each other. The middleware 302 may provide functionality to connect applications intelligently and efficiently. The App servers 303 may include a server that hosts applications or software that delivers a business application through a communication protocol. The upstream systems 301 may include at least one of a mainframe, a card authorization system, a commercial wire system, a deposit ingestion system, or a retail web system. The mainframe may be legacy deposits, Automated Clearing House (ACH) processing, or other legacy transaction types. The upstream systems 301 may have direct integration or communication with third party data providers, such as data providers 307 as shown in FIG. 3. The upstream systems 301 may also provide currency transactions to a case management platform 306. The case management platform 306 may include Suspicious Information Report (SIR)/Suspicious Activity Report (SAR) processing servers, supporting functionality servers, and case management/SIR-SAR processing servers. The SIR/SAR servers may store and manage suspicious information reports and/or suspicious activity reports, and further communicate the suspicious information reports or the suspicious activity reports with the case management/SIR-SAR processing servers. The supporting functionality servers may also communicate with the case management/SIR-SAR processing servers to provide functionality necessary for the SIR-SAR processing. The case management platform 306 may be in communication with an alert and case management platform 305. The alert and case management platform 305 may include a fraud alert database, and one or more operations interfaces on which users may perform fraud alerts operations and/or regulatory case management operations. The upstream systems 301 may have direct integration or communication with third party data providers 307.

The upstream systems 301 may involve: (1) the largely synchronous using of the Simple Object Access Protocol (SOAP), (2) the system is not designed to easily scale or support burstiness, and (3) most integrations (except wires) occur in the “last mile” of the transaction lifecycle. Synchronous transaction may happen in order such that the current task must be completed before moving on to the next task. In contrast, asynchronous transaction may be executed in any order or even at once. A SOAP may be a lightweight Extensible Markup Language (XML)-based protocol that is used for the exchange of information in decentralized, distributed application environments. A last mile may be the last stage in a process, often involving rising marginal cost of completion.

The middleware 302 may include an application integration layer 303, an operational data store (common data plane), and consumers and streaming Apps that are in communication with the operational data store. The middleware 302 may enrich data from mainframe and/or other systems of the upstream systems 301. The middleware 302 may receive data from the data providers 307 and orchestrate interactions with data. The middleware 302 may also send data to a fraud detection platform (or fraud technology platform) 304. The fraud detection platform 304 may include one or more fraud detection databases, one or more supporting functionality servers, and a transactional fraud detection system. The transactional fraud detection system may include Retain Line of Business (LOB) servers, commercial LOB servers, deposit LOB servers, ACH LOB servers, and debit card LOB servers. The upstream systems 301 may also send data to the fraud detection platform 304 through the middleware 301. An SIR application system 308 may communicate with middleware 302 with an SIR entry form. For example, an employee of a bank may enter SIR information to the middleware 302.

The middleware 302 may involve: (1) shared Enterprise Service Bus Infrastructure (ESI) being subject to cross-business capability impact and a large blast radius, (2) scaling being at the cluster level or additional compute, not at component level, (3) inconsistent integration approach across flows, some use SOAP, some use Message Queue (MQ), etc. with no failback, (4) error handling is largely log-based or simple retry loops, (5) fairly primitive distribution approach (no circuit-breaker controls or deep health checks, relying on simple load balancer Hypertext Transfer Protocol (HTTP) probes or health check evaluation tools), (6) not supporting a low-code approach. A queue may be a First-In, First-Out (FIFO) list or structure that is used to buffer information moving from one component/system to another component/system. A Message Queue (MQ) may be a line enables applications running at different times to communicate across heterogeneous networks and systems that may be temporarily offline. Applications send messages to queues and read messages from queues. A low-code approach is an application development method that elevates coding from textual to visual. Rather than a technical coding environment, low-code operates in a model-driven, drag-and-drop interface. F5 HTTP probes may be used to send HTTP(s) requests to a target and verify that a response is received. Health check evaluation tools are tools that serve to assess different aspects of health (is system functioning as expected) systems.

The App Servers 303 may involve: (1) segmentation is via load balancer Virtual Internet Protocols (VIPs) at the business capability level and is not granular enough or based on transaction priority, (2) Currency Transaction Reporting (CTR) database schemas are coaligned with the commercial operations interface and need to be split to new database management system instances, (3) App Servers leverage Virtual Machines (VMs), support for dynamic scaling to meet burst demands is extremely limited, (4) most app components (detection, model execution, policy execution, alert distribution, etc.) are co-located on the same commercial detection and alert distribution engine nodes, and not independently scalable or resilient, (5) all business capability app servers have the same full deployment footprint and codebase (not a lightweight or business capability specific approach, outside of specific configuration file settings), (6) startup time may be too slow, such as 18 minutes or longer in current systems, (7) deployments leverage “installers” and are not at the individual component level (heavy-handed approach), (8) commercial operations interface patches combine app and database (DB) scripts, which makes staging difficult.

The commercial operations interfaces may involve: (1) widgets and commercial real-time, ad-hoc reporting module queries leveraging the same database service, hitting primary instances, whereas they should be separated to leverage read replicas, (2) all users share a single Virtual Internet Protocol (VIP) address, or an endpoint, not segmented based on transaction or alert priority, while high priority (e.g., wires) may need their own instances and VIPs to insulate from others and reduce blast radius.

At least some embodiments of the present application are direct to a method for analyzing attributes of electronic transactions. An electronic transaction may refer to the use of computers or telecommunications to process a banking transaction, such as a payment, funds transfer, account query, debit, credit, or any other transaction. Attributes of electronic transactions may be any property associated with the transaction, such as the transaction source, transaction data (e.g., a transaction amount, merchant location and name information, the receiving account, etc.), the account, such as account age, transaction history, linked accounts, the account owner, third party data, supplemental data, properties of the transaction or account obtained via an algorithm or machine learning model, and/or any other data associated with the transaction. The attributes may be analyzed for fraud risk.

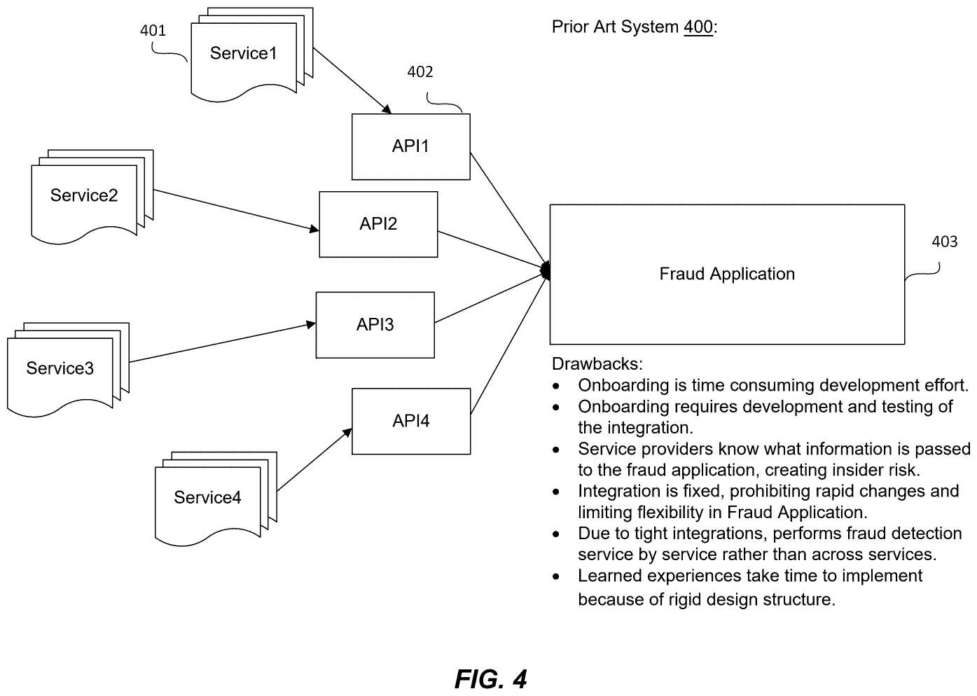

FIG. 4 is a block diagram illustrating the structure of a prior art system 400 and its associated drawbacks. Referring to FIG. 4, services 401 voluntarily onboard data to Application Programming Interfaces (APIs) 402. Each individual service sends data to a separate API. Each API is a published set of information gathered from each service, which are required to provide the information requested by the fraud application 403. The fraud application 400 treats each integration separately.

Prior art system 400 has a number of drawbacks such as: (1) onboarding of the services 401 is a time consuming development effort; (2) onboarding requires development and testing of the integration; (3) service providers know what information is passed to the fraud application, which creates a risk of disclosure of confidential information by an insider; (4) integration is fixed, prohibiting rapid changes and limiting flexibility in the fraud application 403; (5) fraud detection is performed service by service rather than across services, limiting both efficiency and exchange of information; (6) learned experiences take time to implement because of the rigid design structure.

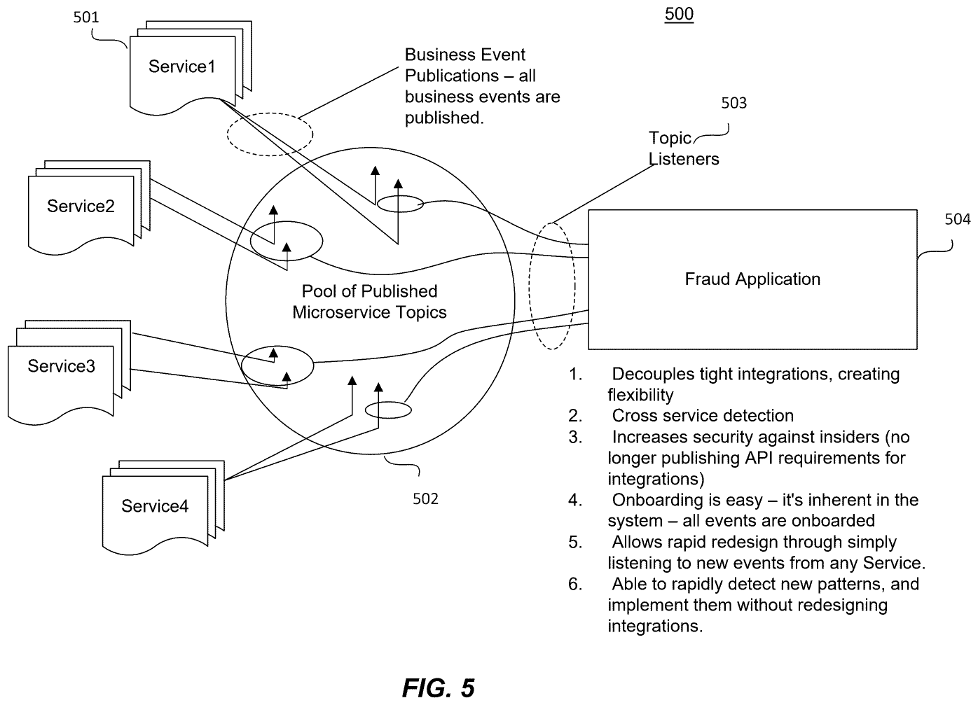

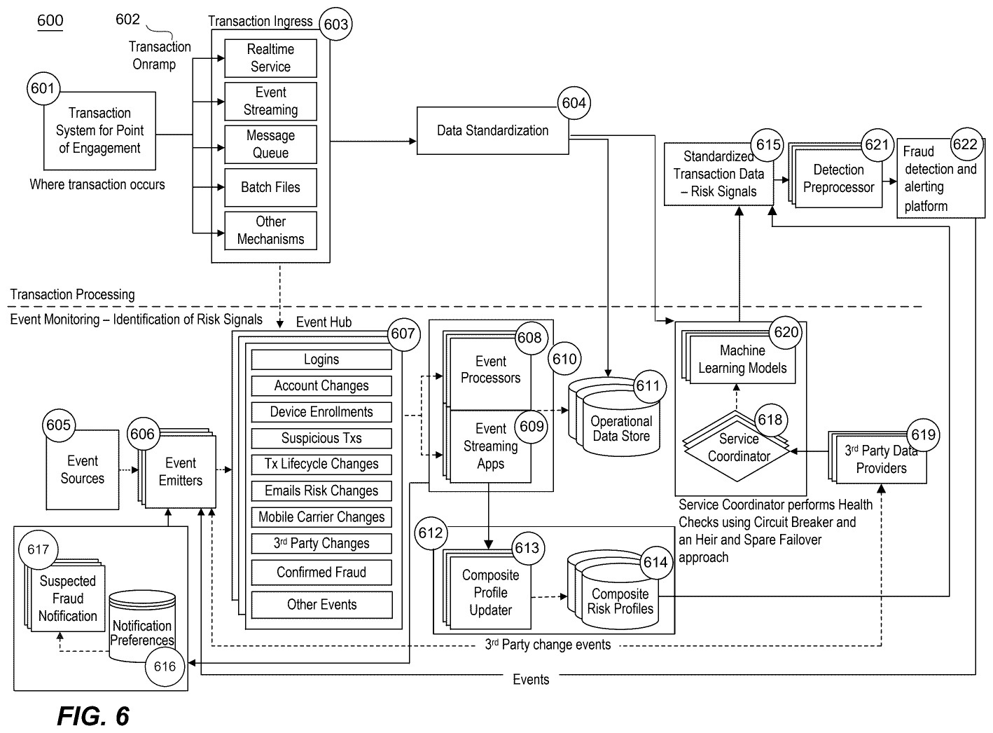

FIG. 5 is a block diagram illustrating a microservice structure 500 consistent with some embodiments of the present disclosure. Referring to FIG. 5, services 501 publish all business events to the Pool of Published Microservice Topics 502. Services 501 may represent one or more event sources from which event data are received. Events occur within the appropriate processing systems. For example, a large number of cash withdrawal events occur in a bank transaction system (e.g., automated teller machine) or a large number of online transfers occur in an online bank transaction system. The events of interest can be collected by configuring one or more upstream systems to publish the events directly to an event hub, or by implementing consumers that emit events to the event hub by leveraging an existing repository in which these events are already stored, such as using log aggregation tools such as Splunk® Enterprise or Falcon LogScale, as described below in regards to FIG. 6. The event monitoring may be a continuous process. Publishing the events to the event hub is performed using event driven programming that is based on the concept of a central event broker (event hub) that receives events from an event publisher (event emitter). The consumers that emit events may be the parties (applications) that are interested in listening (event listener) to a specific event and may subscribe to the event of interest through the event broker.

From there, topic listeners 503 interpret the data from the microservices, and the data is transmitted to fraud application 504. Topic listeners 503, similarly to an event listener, wait for an event to occur and “listen” or track when the event happens. However, topic listeners 503 may also trigger a response in reaction to the event, while event listeners do not. Specifically, topic listeners 503 trigger the interpretation of the data, which may include identifying risk signals based on the events. A risk signal may include any data or information regarding an account or transaction that provides an indication of the level of fraud risk associated with the account or an individual transaction. The data interpretation may also include generating a composite risk signal. A composite risk signal is a collection of risk signals associated with a specific account, account owner, or transaction. Creating a composite risk signal may include analyzing events or transaction data for risk signals and compiling the risk signals into a single composite risk signal.

The risk signals and composite risk signals may be transmitted to fraud application 504, which makes a judgement on the data using internalized business logic, and then outputs the results. The judgement may be based on one or more composite risk signals, one or more additional risk signals obtained by machine learning, or third-party data. The internalized business logic may include rules for how to make a fraud determination based on risk signals.

Microservice structure 500 offers numerous benefits over prior art systems, such as prior art system 400. One such example benefit is that tight integrations are decoupled, creating flexibility in the system. Another such example benefit is that cross service detection is possible because all events from multiple services may be published to the same pool of microservices instead of to individual servers. As such, when application 504 receives data from the pool of microservices, application 504 may receive data from all of the multiple services. A further such example benefit is that security against insiders is improved. The events may be published by the event sources, either directly to the event hub or to a repository that stores some events. Because microservices have many small components, different stacks may be able to use different software or programming languages. As such, the microservice pool will be able to accept data from sources in a variety of different forms, making integration easier and removing the need to publish API requirements for integration. Furthermore, the stacks of microservices do not share the data between services, so insiders will not be able to access the data. Another such example benefit is that onboarding is easy because all events are published and picked up by the system. The event sources publish their event data either directly to an event hub or to a repository of stored event data using an emitter. Since the system can handle multiple types of software due to the option of several microservice stacks, the system can collect event data of different types, making onboarding easier. Another such example benefit is that rapid redesign is possible by listening to new events from any service. Furthermore, additional microservices can be added quickly for relatively low cost. A further such example benefit is that new patterns can be rapidly detected and implemented without redesigning integrations. The fraud detector is rapidly able to receive event data from a variety of services as they occur. Furthermore, the system may use machine learning to generate additional risk signals and learn from patterns. Once new patterns have been identified, updates can be made to the fraud detector application rules or to the microservices themselves without changing how the event sources publish events or are integrated into the system.

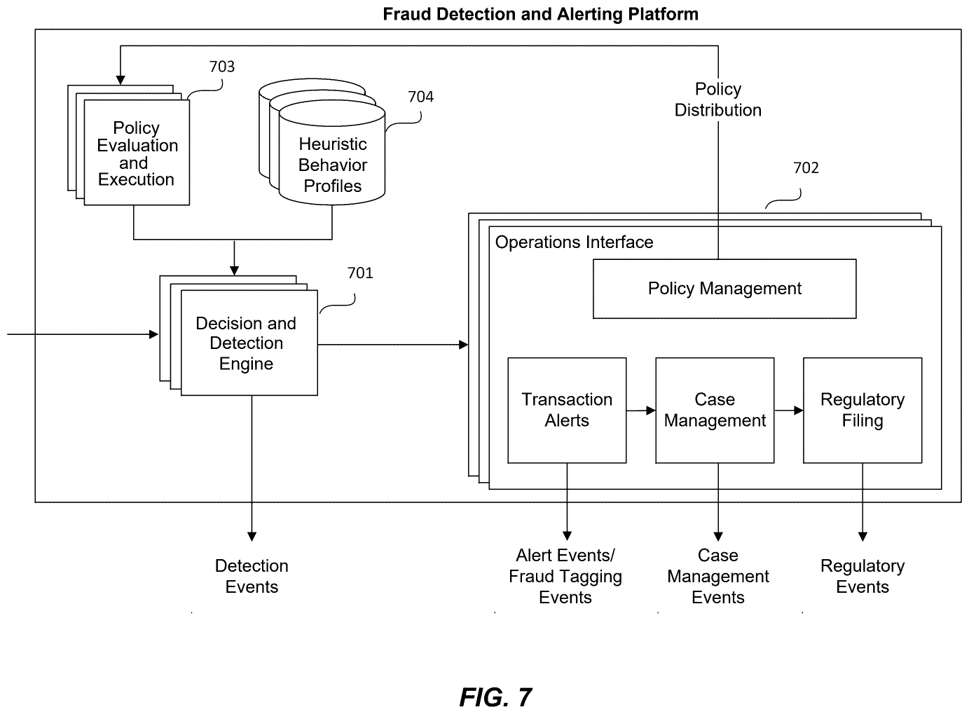

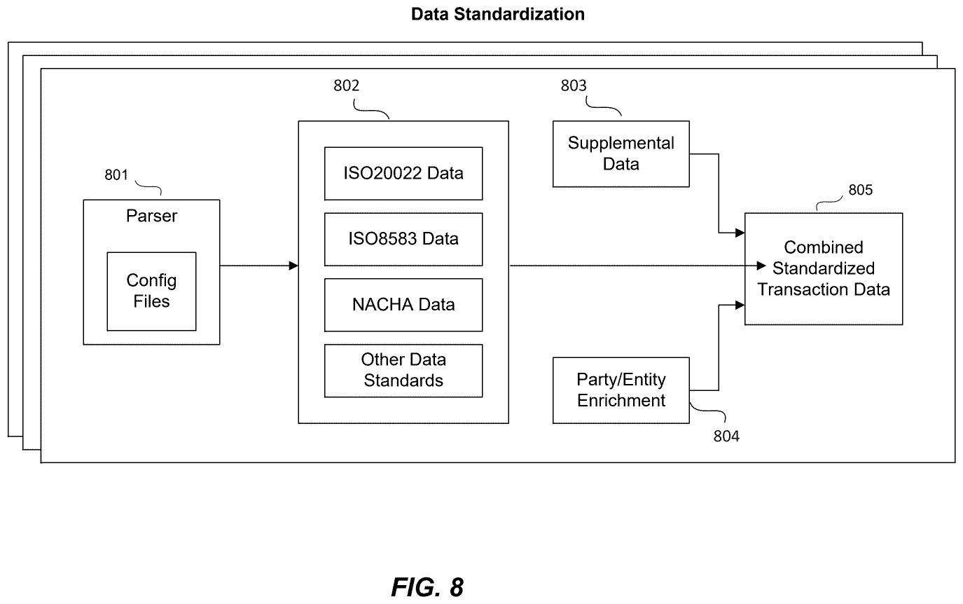

FIG. 6 is an exemplary process diagram illustrating a method for fraud risk analysis, consistent with some embodiments of the present disclosure. FIG. 7 is an exemplary process diagram illustrating a more detailed depiction of the Fraud Detection and Alerting Platform seen in FIG. 6. FIG. 8 is an exemplary process diagram illustrating a more detailed depiction of the Data Standardization step seen in FIG. 6. The method can be performed by a fraud risk analysis platform. Referring to FIG. 6, in a process 601, one or more transactions occur within an appropriate processing system or a point of engagement. Examples of the transaction source systems include a payments portico application, a payments real-time application, an online banking solution, a mobile banking application, a debit authorization application, a mainframe system, a file transfer system, etc. A payments portico application may be an application for a system for recording payments, transactions, etc.

One or more embodiments of this disclosure may include generating a combined standardized transaction data structure based on analysis of transaction data. Generating a combined standardized transaction data structure may include creating or reformatting obtained transaction data or other data that are related to the transaction or account. In some embodiments, the combined standardized transaction data structure may be an internal company standard. In some embodiments, the combined standardized transaction data structure may be an industry standard data structure. The transaction data may be analyzed to determine or extract information that is relevant to match the standardized structure and then be reformatted to fit that structure. In some embodiments, the transaction data may be combined with data from other sources such as third-party data providers or supplemental data. In some embodiments, generating the combined standardized transaction data structure may include a step of obtaining the transaction data.

Referring to FIG. 6, in a process 602, the transaction data of the one or more transactions are obtained or delivered using appropriate mechanisms to a transaction onramp for processing. A transaction onramp may be the point in a transaction workflow when a transaction (work unit) has been identified and ingested by a transaction workflow for processing, completion, and reposited in a system of record (e.g., business record storage). Examples of transaction data may include, but are not limited to, initiating and beneficiary party information, an account number, a transaction amount, merchant location and name information, Global Positioning System (GPS) coordinates or approximate location associated with a device, a web-browser user-agent string or header, an internet service provider name, an internet protocol address, etc.

At a step 603, transaction data are received from transaction ingress. A transaction ingress refers to the entering or delivery of transaction data to the fraud risk analysis platform. In some embodiments, the transaction data are delivered by a real-time service. The real-time services may include, but are not limited to, Application Programming Interface (API) gateway or proxy, microservice, web service, enterprise service bus, orchestration platforms, and remote procedure calls.

In some embodiments, the transaction data are delivered by an event streaming. Event streaming is a continuous flow of data containing information about an event or a change in state. These data may be processed in real-time or near real-time. The event streaming can be done with any currently available software tools (e.g., Kafka®) or future-developed technology.

In some embodiments, the transaction data are delivered by a message queue. A message queue may be a form of asynchronous service-to-service communication used in serverless and microservices architectures. Messages are stored in the message queue until they are processed and deleted. Each message in the message queue may be processed only once, by a single consumer, usually first-in first-out order. The message queue can be any currently available message queue (e.g., IBM® MQ) or future-developed message queue.

In some embodiments, the transaction data are delivered by batch files. Batch files (or batch processing of (data) files) are the aggregation or accumulation of data files over a period of time, that are then processed in some form as a group by a business process logic (usually housed in a software component). Batch processing is an alternative to real-time processing where data is immediately processed as soon as it is available. The batch files can be transferred using any currently available protocols (e.g., secure file transfer protocol) or future-developed protocol. The delivery methods of the one or more transactions are not limited to the above-described methods. The one or more transactions can be delivered by any other suitable methods.

At a data standardization step 604, the combine standardized transaction data structure may be generated. In some embodiments, generating the combined standardized transaction data structure may include a step of parsing the transaction data to extract details of the transaction data. For example, referring to FIG. 8, in a process 801, a parser extracts the details of the transaction data using an appropriate configuration file. The configuration file may contain information about the specific data that is obtained from a specific type of transaction, and a specific format of that transaction data. Using the configuration file for the specific transaction type, the parser can extract the information from the transaction that fits with the standardized transaction data structure, and properly transform the source data format into the desired standardized data format.

In some embodiments, each unique transaction type may have its own configuration file. Examples of the configuration files may include those for defined transaction types, such as person to person payments, wire transactions, Automated Clearing House (ACH) transactions, debit authorization transactions, etc. For example, the system may include a set of configuration files, in which one or more of the configuration files may provide information that may be used for the parser to extract transaction details, and the parser may select the configuration file for the specific transaction and data format. Examples of the configuration files specific to the appropriate standard data formats include, but are not limited to, the currently available or future-developed human-readable data serialization language, database, in-memory cache, key/value pairs, protocol buffer or schema registry, data pipeline tools, etc.

In some embodiments, generating a combined standardized transaction data structure may include transforming the extracted details of the transaction data into a standard-based data structure. For example, in a process 802, the transaction details, which may include the details extracted by the parser, may be reformatted into industry standard-based data structures or proprietary data structures by a transformer. Examples of the industry standard-based data structures may include ISO 20022 data, ISO 8583 data, NACHA data, or any other standard data structures. For example, ISO 20022 is an open and global standard based on the concept of hierarchy. In the ISO 20022 data, the top layer provides the key business process and concept, the middle layer provides logical messages or message models, and the bottom layer deals with syntax. The ISO 20022 uses an extensible markup language (XML) format that is descriptive and understandable. The XML data is marked up clearly with opening and closing tags that indicate the meaning and structure of information. For example, the transaction data or business message can be transformed into the ISO 20022 using the following syntax:
<Document>
. . .
</Document>

In the above noted ISO 20022 syntax, the <Document> is an opening tag and the </Document> is a closing tag. The “Document” indicates that the information is a business/transaction message. The details of the message can be provided between the opening tag and the closing tag.

Transaction details can be transformed into the industry standard-based data structures by, for example, currently available or future-developed data streaming process (e.g., streaming ETL (Extract, Transform, Load)), software language object, microservices, API gateway/proxy, or data pipeline tools. Although different types of data structures may be used, a standard data structure format may be used across all transaction types to allow for easy consumption by other internal or external systems. An easy consumption is a concept to facilitate the ingestion of data by consuming parties (e.g., components, systems, databases, etc.) with minimal effort by the consumer and at low cost to the business (e.g., development and maintenance costs). The costs to consumer data may be inherently high due to the nature of data, and the multitude of disparate ways it can be created and consumed. Providing a process for easy consumption may be akin to providing a data translator that bridges the difference between data producer and data consumer.

In some embodiments, generating a combined standardized transaction data structure may include adding one or more supplemental data elements. For example, in a process 803, supplemental data elements are added to the standardized data structures. Supplemental data are data that are not inherently part of a raw transaction when produced by a transaction producer. A transaction producer may only create that absolute minimal amount of data needed to define the raw transaction, which may be not enough to allow for meaningful consumption by consuming partner systems. Supplemental data can be used to add additional value or context to a raw transaction to flesh out the transaction from a business perspective and make it whole from the perspective of multiple consuming partners. Supplemental data elements may include any transaction data that is not typically included in the standard transaction data for electronic banking. Examples of the supplemental data include, but are not limited to, historical data of the previous transactions, data obtained from social media platforms and related to the transaction, or data provided by foreign financial institutions and related to the transaction, etc. Additional supplemental data may be required for a transaction with a foreign country that is not typically included with the standard data for domestic transactions. Supplemental data elements may be received via a data pipeline tool. Supplemental data may be parsed as described above for the transaction data, formatted into a standardized data structure, and combined with the standardized transaction data to create a combined standardized transaction data structure. The data pipeline tools can be any currently available pipeline tools (e.g., Apache Beam®) or future-developed data pipeline tools.

In some embodiments, generating a combined standardized transaction data structure may include enriching the standard-based data structure with information of at least one of an additional party or entity obtained from analyzing the event data. For example, in a process 804, additional party/entry data sources may be used to enrich the standardized data structure with additional party, account, device, or other entity details. Enriching is performed to make the standardized data structure more valuable or meaningful. The additional data sources may be the sources that are added to enrich or enhance existing data. The additional data sources can be internal, for example, supporting data sources, reference data sources, etc. The additional data sources can also be external, for example, third-party data sources. For example, the standard-based data structure may be enriched by historical transaction data relevant to the current transaction. The historical transaction data may be obtained from a historical log of activities stored in the system. For another example, the standard-based data structure may be enriched by third-party servers (e.g., a foreign institution server, a social media platform, etc.). The system may include a data enrichment API that interfaces with the third-party data sources. The data pipeline tools can be (1) source data, (2) to a destination (which can then also become data sources themselves) and (3) provide data transformation logic to the sourced data as it arrives at the destination. The features of the data pipeline tools may include data integration facilitators, data replication, and low-code. The data pipeline tools can be any tools currently available or future-developed tools. The data pipeline tools may also have data retrieval and/or orchestration functionality.

In a process 805, the transaction details are combined with the supplemental data elements and the additional enrichment information, and are stored in a single data structure used to facilitate consumption. For example, the single data structure may be a hierarchical structure including a top layer for the key business process and concept, a middle layer for logical messages or message models, and a bottom layer with a syntax for details of the transaction data. The combined standardized transaction data structure may be provided as an input to machine learning models. Alternatively or additionally, the single data structure may be an array, a table, a list, a graph, or a tree.

Some disclosed embodiments include the process of event monitoring and identification of risk signals. Referring to FIG. 6, in a process of 605, event data are received from one or more event sources. The event monitoring may be a continuous process. Based on the monitored event data, risk signal may be identified, one or more composite risk signals may be created or updated. A risk signal may include any data or information regarding an account or transaction that provides an indication of the level of fraud risk associated with the account or an individual transaction (e.g., an account with a password older than 12 months may indicate higher risk, a transaction for a large amount of funds may indicate higher risk, a transaction made using a physical card may indicate lower risk, a login from the account owners home or cell phone may indicate lower risk, a log in for a foreign country may indicate higher risk, etc.).

A composite risk signal is a collection of risk signals associated with a specific account, account owner, or transaction. Creating a composite risk signal may include analyzing events or transaction data for risk signals and compiling the risk signals into a single composite risk signal. Updating a composite risk signal may include adding a new risk signal or replacing an older outdated risk signal with a new risk signal (e.g., if the account recently had a password change from the account owners home IP address).

In some embodiments, creating or updating one or more composite risk signals based on analysis of event data may include collecting the event data. For example, in a process 606, the data of the events of interest are collected and emitted to an event hub 607 by an emitter. An emitter may be used in event-driven architecture (architecture that is focused on event creation and consumption for real-time processing, as opposed to batch processing). An emitter may be a component or system that generates an event that is of interest to another component or system. An emitting may be the action of publishing or broadcasting the “fact” that an event has occurred. Examples of the events of interest may include, but are not limited to, a login to an online banking account; a login to a mobile banking app; a call to an automated Interactive Voice Response (IVR) system; a call to a customer care center; a demographic or account data change (e.g., change of address, change of telephone number, change of email address, addition of new authorized account contact, change in notification/alert preferences); an account lifecycle events (e.g., application for a new account, closure of an existing account, addition of a new beneficiary, addition of a new external account); a device lifecycle events (e.g., new device registration, mobile carrier change, mobile carrier disconnect, device subscriber identity module (SIM) change, device unenrollment, device malware present); a card lock status change; a new contribution to hotfile; suspicious transactions; third party changes; confirmed fraud; a new contribution to shared database; a new contribution to shared database or from a consortium/partner; and transaction lifecycle/state changes.

The events of interest can be collected by configuring one or more upstream systems to publish the events directly to an event hub, or by implementing consumers that emit events to the event hub by leveraging an existing repository in which these events are already stored, such as using log aggregation tools such as Splunk® Enterprise or Falcon LogScale. Publishing the events to the event hub is performed using event driven programming that is based on the concept of a central event broker (event hub) that receives events from an event publisher (event emitter). The consumers that emit events may be the parties (applications) that are interested in listening (event listener) to a specific event subscribe to the event of interest through the event broker. In some embodiments, the types of events that should be continually monitored include, but are not limited to, login to online banking, login to mobile banking, call to an automated IVR system, call to a customer care center, demographic or account data change (change of address, change of telephone number, change of email address, addition of new authorized account contact, change in notification/alert preferences), account lifecycle events (application for a new account, closure of an existing account, addition of a new beneficiary, addition of a new external account), device lifecycle events (new device registration, mobile carrier change, mobile carrier disconnect, device SIM change, device unenrollment, device malware present), card lock status change, new contribution to hotfile, new contribution to shared database or from consortium/partner, and transaction lifecycle/state changes.

In some embodiments, creating or updating one or more composite risk signals based on analysis of event data may include emitting, by an event emitter, the event data to an event hub. In this step, the event emitters and event hub may simply collect the data that might be of interest. The subsequent event pre-processors and event stream apps can make the business determination as to which events warrant creating or updating the corresponding risk signals, such as whether a recent login was considered risky, or whether a recent account update was performed. The event hub stores the collected event data for analysis. In some embodiments, the event emitters may be configured to populate and emit only events of interest. In some embodiments, the event emitters may be adjusted such that the event hub can collect all manner of events. In some embodiments, a source format of an event source can be preserved, and the event pre-processors or event streaming apps may process the event data and to make the business determination as to whether that particular event warrants creation of or updates to a risk signal. The events of interest may be continuously monitored.

Some disclosed embodiments include analyzing the event data to determine if one or more composite risk signals need to be triggered or updated. A risk signal may be a discrete event that has risk context to a business process. When an event is emitted and it has risk context, if it is detected and meets the threshold for the risk context, a risk signal may be triggered. This may have implications for the business including the need to elevate the importance of the event and to ensure that the risk is taken into account by the business. For example, in a process 608, the event pre-processors analyze the event data, where streaming is not appropriate, to determine if composite risk signals need to be updated or triggered. The streaming apps may process the event messages in a continuous, real-time manner, and may apply data aggregations and analytical functions over a window of time. Data aggregation is a process of collecting/clustering of data into a new data artifact. An analytic function may refer to a mathematical definition that is defined as a function that is locally given by the convergent power series. The analytic function can be mean/average, or far more complex/custom algorithms. In some embodiments, the event messages come in and need to be processed and/or stored without applying a streaming function to this unbounded flow of data. Applying a streaming function may include a data operation (function) that is designed to operate on a continuous flow of data (streaming) such as a live video/audio source. A live video/audio source can be a source that is continually emitting data non-stop. These events may be infrequent events such as a device swap event. During the processing, categorizing, and analyzing these flows of event messages, a risk signal data point, such as “a significant account balance change” or “a device takeover indicator” or “a geographic distance between money movement events”, can be created or updated. In some embodiments, the risk signals are not static; they change over time as apparent risk increases or decreases based on the event data flows. For example, a risk signal for the location of the last account log in may exist as part of the composite risk signal. Every time the account is logged into, the risk signal for location of last log is updated with the new location and different locations may indicate different levels of risk. The types of risk signals that composite profiles may contain include, but are not limited to, a recent risky call, a recent risky login, a recent device enrollment, a recent demographic change (email address change, address change, telephone number change), demographic change attempted (email address change attempted, email address enrollment attempted, address change attempted, telephone number change attempted), date of last demographic change (last address change date, last email change date, last telephone number change date), a recent email risk elevation, a recent device risk elevation, a recent beneficiary change, a recent high value transaction, a presence on internal hot-file, and a presence on national shared database.

In some embodiments, events (e.g., fraud outcome events) may be emitted to the transaction system or point of engagement by the event emitters. In some embodiments, the event emitters may receive events (e.g., transaction lifecycle changes and other derived events) from transaction ingress. The transaction lifecycle changes and other derived events may be further emitted to the event hub by the event emitters. The transaction lifecycle changes may include authorization of the transaction, clearing the transaction, settlement of the transaction, or any other changes in the status of the transaction.

In some embodiments, in a process 610, event processors and streaming apps determine which events are of interest and take appropriate action(s). The actions include enriching with third party data, invoking other services, or emitting new events. In particular, in a process 608, one or more event processors may analyze events, where streaming is not appropriate, to determine if composite risk signals need to be updated or triggered. In a process 609, the event streaming apps analyze the events, where streaming is appropriate, to determine if composite risk signals need to be updated or triggered. A composite risk signal may be composed (aggregated) from multiple discrete source signals that are combined to create a single signal indicating the current state of risk (for a customer). The discrete source signals arrive at random times and not all may trigger a recalculation and update of the current state of risk. The analyzed event data can be provided to the machine learning models as input. In some embodiments, defined risk signals may be passed or provided as input to one or more machine learning models, which can allow the models to leverage these additional indicators without having to make costly calls to other systems to obtain this information. By aggregating signals before passing them to a machine learning model, the operating efficiency is increased.

Some disclosed embodiments include storing the event data for enrichment of at least one of a party, account, device, or entity. Enrichment may refer to enriching data which is adding/combining data in order to enhance understanding of the original/source data, and/or to provide new value/insights to the source data. For example, near distance enrichment data can be provided. In particular, in a process 611, the event data is stored in the operational data store for use during party, account, device, and entity enrichment. For example, the operational data store may store additional information associated with the party (e.g., previous transaction history of the party, the party's association with a foreign bank accounts, employment history of the party, criminal history of the party, travel history of the party, and the party's social media account postings, etc.) such that these additional information can be retrieved and to be added to the standardized transaction data structure for enrichment. Some enrichment data can be transferred a high-performance cache so that the cache can immediately provide enrichment data without delay. The high-performance cache can be any cache memory that are currently available or developed in the future. As described above for process 804, referring to FIG. 8, the analyzed enrichment data may be added to the standardized transaction data structure to provide additional details of the transaction for fraud risk analysis. For example, data on account lifecycle events (e.g., application for a new account, closure of an existing account, addition of a new beneficiary, addition of a new external account) may be added to the standardized transaction data structure. In some embodiments, the enrichment may be invoked by the event processors 608, referring to FIG. 6. In some embodiments, the enrichment data may be provided by an enterprise data platform.

Some embodiments may include updating the one or more composite risk signals. For example, in a process 612, composite risk profiles are created, stored, retrieved, and/or updated. In particular, in a process 613, a composite profile updater creates or updates the appropriate risk signals within the composite risk profiles. The composite profile updater may determine that the login risk signal needs to be updated for a composite risk profile associated with a specific user because a recent risky login was detected, such as a login from a foreign country.

Some embodiments may include storing the created or updated one or more composite risk signals for a specified party, account, device, or entity. For example, in a process 614, the composite risk profiles store a collection of risk signals for a specified party, account, device, or entity, etc., and act as a central repository of risk signals. The risk signals may include a recent risky login, a recent device enrollment, a recent account data change, an email compromise, and an account take over indicator, etc. The stored risk signals can be provided to the machine learning models as inputs to generate additional risk signals. The stored risk signals can also be retrieved by the event processors. The composite risk signals can be updated based on the information from the event processing services 610. The composite risk signals can also be added to standardized transaction data (e.g., 615).

Customers may send notifications or messages to customer notification services, with adjustable notification preferences 616, when suspicious activity is detected on their accounts. As a response, the customer notification services may also send messages or notifications to the customers. In a process 617, the notifications or the messages from the customers are processed, and suspected fraud notification are emitted via the event emitters 606. The customer notification services may also receive messages or notifications from the event processing services 610 for the detected suspicious transaction events.

The event data may be used to trigger other actions and call other services. The other services may include any services, for example, notifying an account user, notifying a manager of a financial institution, notifying a law enforcement, etc.

In a process 618, the service coordinator may orchestrate the invocation of third-party data providers 619 using the combined data structure and appropriate health-check observations used to implement a circuit breaker-based heir and spare failover strategy. The service coordinator may be a computer system that automatically performs the coronation/orchestration function or a computer system that performs the function under human control/intervention. The data from the third-party providers may be obtained to identify additional risk signals, such as email and mobile operator information, device intelligence data, etc. The third-party data may be provided by external business partners. These partners may collect, aggregate, and then provide the data. The data can be sourced from public or private sources. The data may be used by subscribing businesses to enhance and enrich their existing data for specific business purposes. A circuit-breaker control may involve a computer system detecting a fault condition within a particular component, module, or capability. A circuit breaker may be an IT architecture concept that is designed to cut or throttle communications between two systems. A circuit-breaker can be in an open, closed, half-open (or half-closed), or partially-open (or partially-closed) state. The purpose of the circuit breaker may be to help manage communications issues between systems gracefully and to circumvent either system failing. Generally, a circuit breaker may evaluate the overall system health of a particular component, and may be used to determine whether data or requests should be distributed to a particular component, or if they should be distributed elsewhere. System health may refer to the expectation that a healthy system is available and is performing its expected work as documented. An unhealthy system may be either non-available and/or not performing its assigned work as documented. The circuit-breaker may determine that a particular component is healthy (closed), and may allow requests to flow. A request to flow refers to communications between two systems. Systems communicate between themselves by sending data. The sending of data from one system to another can be considered a flow. Flows may consist of data that is used to accomplish a defined task. Additionally, or alternatively, the circuit-breaker may determine that the component is down (open) and may prevent requests from being distributed. Additionally, or alternatively, the circuit-breaker may determine that a subcomponent is unhealthy, such as when a service is available, but the underlying database is not available, in which case, the circuit-breaker would be half- or partially-open, and requests may be distributed to another component, or not at all. In some embodiments, the terms heir and spare may refer to having a preferred/primary and any number of secondary/backup providers for any given data or service provider. These may be used when a particular third-party other entity is unavailable, during which time we may divert requests to another provider. For example, the service coordinator may invoke an API that interfaces with the third-party data system (or server) to request additional data. The additional data provided by the third-party data system (or server) is obtained by the service coordinator. The service coordinator may send the obtained additional data to the data standardization services such that the additional data can be analyzed as additional risk signals.

Some embodiments include providing third-party data to the event emitters so that the event emitters emit the additional risk signals. The third-party providers may be the external business partners and the data is usually obtained via a subscription or contract with the third party. Data may be used to enhance or enrich internal data to provide additional value or insights. Examples of third-party data may include weather or public demographic data. The third-party data may be emitted by the event emitters. The third-party data may be provided to the standardized transaction data as an additional risk signal. In some embodiments, the third-party data may be provided as an alternative event source. In some embodiments, the third-party data are used in combination with other event sources. The third-party data may also be provided to the machine learning models.

Some disclosed embodiments include obtaining one or more additional risk signals using machine learning based on at least one of: the combined standardized transaction data structure, the one or more composite risk signals, the event data, or third-party data received from a third-party data provider. A machine learning algorithm may be a series of programmatic steps specific to the application of machine learning. The machine learning algorithms (models) may include an extreme gradient boosted trees classifier, a random forest model, a neural network, a support vector machine, a naive Bayes classifier, a classifier, a k-nearest neighbors algorithm, a linear regression model, a deep learning model, or any other type of suitable model for processing input data to generate a corresponding output. Machine learning may have many applications, such as voice or image recognition, and the algorithm may take the voice or image data as input, process it via the algorithm and then output the results. The machine learning algorithms listed here are merely examples. The method disclosed in this application can use any machine learning algorithms. The training of the machine learning model may include, for example, supervised learning, semi-supervised learning, unsupervised learning, and/or reinforcement learning. The testing of the machine learning model may include, for example, an evaluation of the performance of the machine learning model (e.g., based on a testing method, a validation method, a cross-validation method, an out-of-sample testing method, or any other suitable method).

In some embodiments, obtaining the one or more additional risk signals by machine learning may include inputting at least one of the combined standardized transaction data structure, the one or more composite risk signals, the event data, or the third party data into a machine learning model. An additional risk signal may be a property of the transaction, account, event data, or other associated data that provides information on the level of fraud risk associated with the transaction that was not previously identified. The machine learning model may include a plurality of input nodes, one or more intermediate nodes, and/or one or more output nodes. To generate an output based on a particular set of inputs (e.g., the combined standardized transaction data structure, the one or more composite risk signals, the event data, or third-party data received from a third-party data provider), the values of the input nodes of the machine learning model may be set to the combined standardized transaction data structure and/or any other designed input. Each of the input nodes of the machine learning model may configured to correspond to one of the data input types (e.g., the combined standardized transaction data structure, the one or more composite risk signals, the event data, or third-party data received from a third-party data provider). For example, the machine learning model may include a plurality of input nodes corresponding to the different types of input data. For example, the machine learning model includes an input node corresponding to third-party data, and when the input data include third-party data, the third-party data is inputted to the corresponding node (for the third-party data) of the machine learning model. The populated input nodes may then be analyzed by the machine learning algorithm to produce the desired output, an additional risk signal, which may tie that output to additional numeric values such as probabilities (e.g., a likelihood that an attribute of the transaction indicates a fraudulent transaction or a numeric value for representing the risk associated with the additional signal). For example, the machine learning algorithm may receive input of the composite risk profiles, with composite risk signals, as an input, and the combined standardized transaction data as another input. The algorithm may analyze or compare the two data sets to produce one or more additional risk signal. For example, if the transaction location indicated a fraud risk, such as being initiated in a foreign country, the algorithm may identify transaction location as an additional risk signal. The additional risk signal could be any property the event data, standardized transaction data, or information derived or predicted from that data.

The machine learning model may include a numeric output, such as a value quantifying the level of risk associated with the additional risk signal. For example, a small transaction may be given a low risk value (e.g., 0-25), while a large transaction is given a high risk value (e.g., 75-100). Other properties may have various associated risk values, for example, a deposit may receive a low risk value, while a transfer to a merchant may have a medium risk value, and a transfer to another bank account may have a high risk value.

The machine learning models may leverage an appropriate model feature store containing the data that may be used to execute the machine learning model, which can be extended with additional risk signals obtained from the composite risk profiles 614, information obtained by the event processors 608 and event streaming apps 609, and information obtained from third party data providers. A model feature store may be a central location (central data management layer) to store and provide curated features for machine learning pipelines to support the development and production of models. The types of the composite risk signals obtained from the composite profiles may include, but are not limited to, a recent call; a recent login; a recent device enrollment; a recent demographic change; a recent email risk elevation; a recent device risk elevation; a recent confirmed fraud; a recent beneficiary change; a recent high value transaction; a presence on an internal hotfile; and a presence on national shared database. The process of training the machine learning model may include providing a machine learning algorithm with training data to learn from. The training data may be manually selected or automated retrieved from the system storages from historical transactions log. The learning algorithm finds patterns in the training data that map the input data attributes to a target answer, and outputs a machine learning model that captures the patterns. The machine learning model can be any currently available models (e.g., regression, binary classification, multiclass classification, etc.) or future-developed models.

The machine learning models may also use inputs from the event data obtained by analyzing events continuously monitored, as discussed below. Still referring to FIG. 6, in a process 605, events occur within the appropriate processing systems. For example, a large amount of cash withdrawal event occurs in a bank transaction system (e.g., automated teller machine) or a large amount of online transfer occurs in an online bank transaction system.

In a process 615, the combined data structure may be extended with the signals obtained from the machine learning models (620), the signals obtained from third-party data providers (619), the signals obtained from the composite profile service (612) that are computed during event processing, to provide a holistic view of risks. A holistic view of risk may imply bringing as wide a view as possible and including as much data as possible in order to assemble an accurate risk profile or as best as possible. The outputs of the machine learning models may include numeric score values, or model outputs (e.g., additional risk signals). Additionally or alternatively, the machine learning models can output categorical values, such as high risk or low risk.

Some embodiments further include preparing, by a detection preprocessor, an ingestion into a decision engine based on at least one of the combined standardized transaction data structure, the one or more composite risk signals, the one or more additional risk signals obtained by machine learning, or the third party data. A decision engine may be a component/system that takes an input (data) and makes a judgement (decision) on the data using internalized business logic, and then outputs the results (decision). Decision engines are designed to do one thing very well and very fast and that is make a decision. In a process 621, the combined standardized transaction data structure, risk signals, including the stored created or updated composite risk signals and/or the additional risk signals from the machine learning model, or third-party data may be transformed and prepared for ingestion into a decision engine by a detection preprocessor. Ingestion may refer to a process of obtaining and importing data for immediate use or storage. The detection preprocessor prepares the data for ingestion by formatting the data in a manner that a commercial fraud detection platform can consume, which may be a standardized format or a proprietary format specific to the platform. The detection pre-processor is used to make sure that the decision engine operates efficiently. For example, the detection preprocessor may prepare the data that feeds the decision engine so that no additional preparation work is required for the decision engine to perform its task.

Some embodiments of the present disclosure include evaluating at least one of the combined standardized transaction data structure, the one or more composite risk signals, the one or more additional risk signals, or the third party data. When data is sent to a decision engine, the decision engine may evaluate the data to render a decision. The evaluation logic and processing may be internal to the decision engine (which may be optimized for speed to handle or process a large number of requests, tasks, or decisions during a period of time). Referring to FIG. 7, in a process 701, a decision and detection engine receives inputs from the detection preprocessor and output the decisions to an operations user interface 702. The operations user interface 702 may include a policy management module that provides policy distribution to a policy evaluation and execution 703. The policy evaluation and execution 703, in turn, may provide the evaluation and execution results to the decision and detection engine 701. A heuristic behavior profiles 704 also provides inputs to the decision and detection engine 701. The heuristic behavior profiles 704 may be generated by applying heuristic analysis methods to data. A heuristic analysis method may refer to a method of detecting anomalies by monitoring for suspicious properties. A heuristic behavior profile may refer to a collection of the identified normal activities and may be applied when looking for behavior outside of normal. The decision and detection engine 701 may identify a detection event, which may include events that indicate fraud may have occurred (e.g., low balance detection, overdraft detection, unusual account activity, account owner change, etc.). The operations user interface 702 may further include alert management module, case management module, and regulatory filing module. The alert management module may provide inputs to the case management provider, and the case management provider may provide inputs to case management module, and the case management module may provide inputs to the regulatory filing module. Detection of fraud may raise an alert which may escalate into investigation/intervention and also result in some form of action being taken. Case management messages and regulatory filing messages may include messages/data sent to a regulatory agency that contain information concerning customers and their activities, as defined by the regulatory requirements. In some embodiments, at least one of a detection event, a transaction alert, a case management message, or a regulatory filing message is provided to the event emitter as feedback. The detection events output from the decision and detection engine 701, the risk alerts output from the alert management module, the case management message output from the case management module, and the regulatory filing message output from the regulatory filing module can be provided to the event emitters as feedback, where the data can be processed and collected as event data as described for process 606 above. For example, the feedback provided by the regulatory filing provider can be a suspicious information report submission or a suspicious activity report submission. In this way, a risk signal is promoted to an alert, and is further promoted to a case. In some embodiments, the fraud detection and alerting platform may already be configured to receive canned out-of-the box events and generate, internally, canned out-of-the box risk signals, and the system may be configured to provide supplemental or enhanced risk signals to be consumed by the fraud detection and alerting platform either (a) simultaneously and in combination with the canned out-of-the box signals or (b) separate and apart from the canned out-of-the box signals or (c) as alternatives to the canned out-of-the box signals.

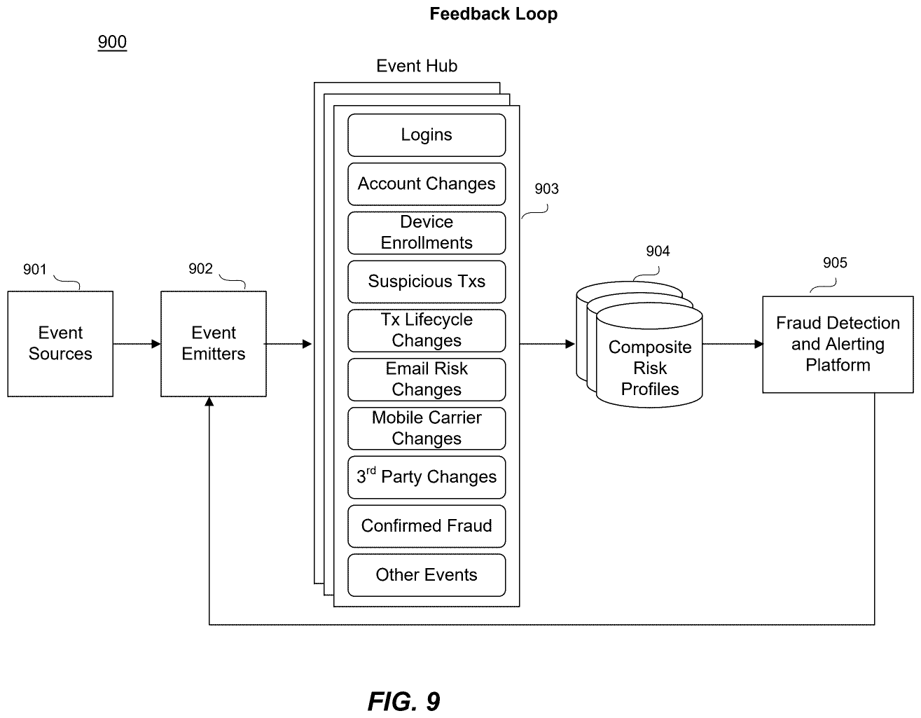

FIG. 9 is a simplified schematic process diagram illustrating a core feedback loop 900 consistent with some embodiments of the present disclosure. In a process 901 event data are received from one or more event sources. In a process 902, the data of the events of interest are collected and emitted to an event hub 903 by an emitter. An emitting may be the action of publishing or broadcasting the “fact” that an event has occurred. Examples of the events of interest may include, but are not limited to, a login to an online banking account; a login to a mobile banking app; a call to an automated Interactive Voice Response (IVR) system; a call to a customer care center; a demographic or account data change (e.g., change of address, change of telephone number, change of email address, addition of new authorized account contact, change in notification/alert preferences); an account lifecycle events (e.g., application for a new account, closure of an existing account, addition of a new beneficiary, addition of a new external account); a device lifecycle events (e.g., new device registration, mobile carrier change, mobile carrier disconnect, device subscriber identity module (SIM) change, device unenrollment, device malware present); a card lock status change; a new contribution to hotfile; suspicious transactions; third party changes; confirmed fraud; a new contribution to shared database; a new contribution to shared database or from a consortium/partner; and transaction lifecycle/state changes. In a process 904, composite risk profiles are created, stored, retrieved, and/or updated. In particular, a composite profile updater creates or updates the appropriate risk signals within the composite risk profiles. In a process 905, a fraud detection and alerting platform evaluates the combined transaction data and risk signals to execute appropriate policies, distribute alerts, and perform other appropriate functions. The fraud detection and alerting platform may provide as feedback to the event emitters 902 at least one of a detection event, a transaction alert, a case management message, or a regulatory filing message.

In at least some embodiments, the feedback provided by the fraud detection and alerting platform will then be passed on to the event hub 903 and then used to update an existing or generate a new composite risk signal at composite risk profiles 904.

Benefits of the disclosed feedback loop may include enhanced pattern recognition as the system is able to learn from prior events and decisions. The fraud detection and alerting platform 905 may provide events back into the system, at 902. These events may then be considered to generate new composite risk signals or update old composite risk signals at the composite risk profiles 904. Thus, the system can use older events and decisions to influence the latest judgements. A further benefit may include increased flexibility and adaptability to changes. As new information is received, it can be input as event data at step 902. It is then collected and emitted at step 903, and then used to generate composite risk signals at step 904. The composite risk signals then affect the judgements made by the fraud detection and alerting platform at step 905, which are then fed back into the system as event data at step 902. Thus, new information is immediately considered and is also taken into account at future decision points. Another benefit may include increased ability to share information with other processes. The fraud detection and alerting platform may provide as feedback to the event emitters 902 at least one of a detection event, a transaction alert, a case management message, or a regulatory filing message. A further benefit may include easy and fast implementation of changes and new information. As new information is received and recognized, it is automatically fed back into the system by the fraud detection and alerting platform 904, improving implementation speed.

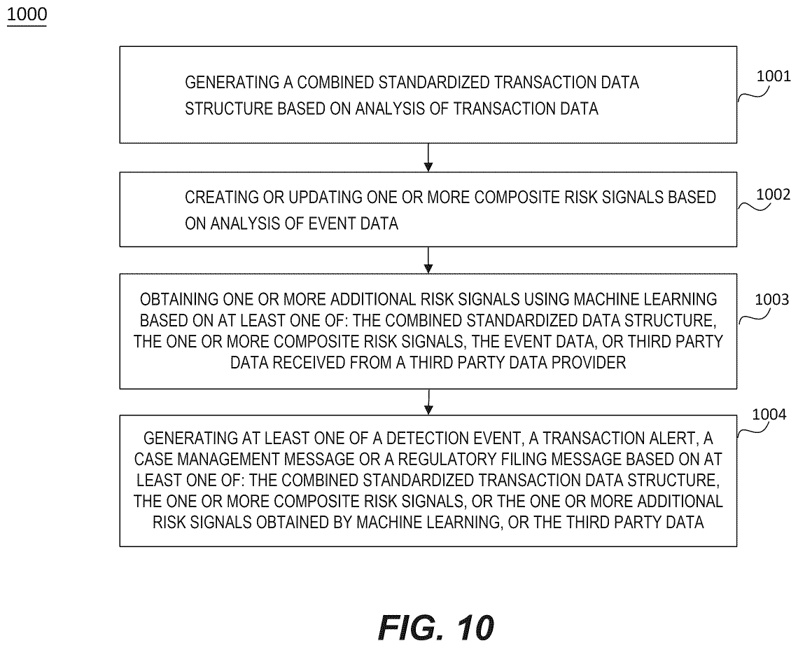

FIG. 10 shows a flowchart of an example method 1000 for analyzing attributes of electronic transactions, according to the present disclosure. In a step 1001, the method 1000 may include generating a combined standardized transaction data structure based on analysis of transaction data. For example, as explained for process 601 and 615 above, the transaction data may be received. The transaction data can be parsed to extract details of the transactions, and then the data can be transformed to an industry standard format. The transaction data may be further combined additional data, such as event data or supplement data, to create combined standardized transaction data, that can be input into a machine learning model.

In step 1002, the method 1000 may include creating or updating one or more composite risk signals based on analysis of event data and may be understood as described above. For example, a composite risk signal may be created if a user logs in on a new device. In another example, a composite risk signal may be updated if a user requests to process a high value transaction.

In step 1003, the method 1000 may include obtaining one or more additional risk signals using machine learning based on at least one of: the combined standardized transaction data structure, the one or more composite risk signals, the event data, or third-party data received from a third-party data provider as described above.

In step 1004, the method 1000 may include generating at least one of a detection event, a transaction alert, a case management message, or a regulatory filing message based on at least one of: the combined standardized transaction data structure, the one or more composite risk signals, or the one or more additional risk signals obtained by machine learning, or the third-party data as described above. For example, if the risk signals for a transaction are high, and the standardized transaction data structure contains data indicative of fraud, a detection event may be triggered and a transaction alert may occur, by flagging the transaction for review or canceling it.

In some embodiments, the above-described methods are implemented in a single computer system (or a device) having multiple modules. For example, the single computer system (or the device) may include: a data standardization module that receives transaction data and generates combined standardized transaction data; an event monitoring module that receives event data and generates composite risk signals; a machine learning module that receives inputs of the combined standardized transaction data, the event data, the composite risk signals, and third party data, and generates additional risk signals; and a fraud detection module that receives the standardized transaction data, the composite risk signals, the additional risk signals identified by machine learning, and the third party data, and generates at least one of a detection event, a transaction alert, a case management message or a regulatory filing message.

In some embodiments, the above-described methods are implemented in a distributed system including multiple computers. For example, the distributed system may include: a first computer that receives transaction data and generates combined standardized transaction data; a second computer that receives event data and generates composite risk signals; a third computer that receives inputs of the combined standardized transaction data, the event data, the composite risk signals, and third party data and generates additional risk signals using machine learning; and a fourth computer that receives the standardized transaction data, the risk signals, the third party data and generates at least one of a detection event, a transaction alert, a case management message or a regulatory filing message. The multiple computers may be interconnected using any desired communication protocols or communication technologies (e.g., Wi-Fi, Bluetooth, infrared, WiMAX, cellular (e.g., 2G, 3G, 4G, or 5G), a satellite network, a near-field communication (NFC) network, a low-power wide-area networking (LPWAN) network, a mobile network, a wireless ad hoc network, a terrestrial microwave network, an Ethernet network, a telephone network, a power-line communication (PLC) network, a coaxial cable network, an optical fiber network, etc.).

In some embodiments, at least part of the methods is performed in a cloud computing system or a remote server. For example, in some embodiments, the enrichment data are stored in a remote server and provided to the fraud detection and alerting platform upon request. In some embodiments, the composite risk profiles may be stored in a remote server and accessed by the machine learning model upon request. In some embodiments the processing performed by the machine learning model or the decision and detection engine occurs in a remote server.

The single computer system or the multiple computers in the distributed computing system may include one or more processors. The processors may include one or more dedicated processing units, application-specific integrated circuits (ASICs), field-programmable gate arrays (FPGAs), central processing units (CPUs), graphics processing units (GPUs), digital signal processors (DSPs), integrated circuits, microcontrollers, microchips, microprocessors, other units suitable for executing instructions or performing logic operations, or various other types of processors or processing units.

The single computer system or the multiple computers in the distributed computing system may include one or more memories. The memories may be any type of computer-readable storage medium including volatile or non-volatile memory devices, or a combination thereof. The memory may store the transaction data and the processing results of the transaction data. The memory may store the event data and the analysis results of the event data. The memory may also store computer-readable instructions, mathematical models, and algorithms that are used in data processing and analysis. In some examples, the memory may include, for example, volatile memory, non-volatile memory, flash drives, caches, registers, hard drives, disks, an optical data storage medium, a physical medium with patterns, random access memory (RAM), read-only memory (ROM), programmable read-only memory (PROM), erasable programmable read-only memory (EPROM), compact disc read-only memory (CD-ROM), digital versatile discs (DVDs), non-volatile random-access memory (NVRAM), or networked versions thereof.

The single computer system or the multiple computers in the distributed computing system may also include input/output device that can be used to communicate a fraud risk alert a user or another device. The input/output device may include a user interface including a display and an input device to transmit a user command to the processors. In some examples, the input device may include, for example, a keyboard, a mouse, a touch screen, a joystick, a touch pad, one or more buttons, a microphone, a sensor, and/or any other device configured to detect and/or receive input. In some examples, the output device may include, for example, a display (e.g., a light-emitting diode (LED) display, a liquid-crystal display (LCD), an organic light-emitting diode (OLED) display, or a dot-matrix display), a screen, a touch screen, a headphone, a speaker, a light indicator, a light source, a device configured to provide tactile cues, and/or any other device configured to provide output. In some examples, the single computer system or the multiple computers in the distributed computing system may include one or more network interfaces (e.g., a network card, a modem, and/or any other device that may be configured to provide data communication via a network).

The computer-readable storage medium of the present disclosure may be a tangible device that can store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

The computer-readable program instructions of the present disclosure may be assembler instructions, instruction-set-architecture (ISA) instructions, machine instructions, machine-dependent instructions, microcode, firmware instructions, state-setting data, or source code or object code written in any combination of one or more programming languages, including an object-oriented programming language, and conventional procedural programming languages. The computer-readable program instructions may execute entirely on a computing device as a stand-alone software package, or partly on a first computing device and partly on a second computing device remote from the first computing device. In the latter scenario, the second, remote computing device may be connected to the first computing device through any type of network, including a local area network (LAN) or a wide area network (WAN).

In some embodiments, a processor is configured to receive, e.g., from a memory or via an input/output subsystem, a set of instructions which when executed by the processor cause the event monitoring system to perform one or more operations described herein. In some embodiments, a processor is further configured to receive, e.g., from the memory or via the input/output subsystem, one or more signals from external sources, e.g., from peripheral devices or via communication circuitry from an external compute device or external source or external network. As one will appreciate a signal may contain encoded instructions or information. In embodiments, once received, such a signal may first be stored, e.g., in a memory or, e.g., in data storage device(s), thereby allowing for a time delay in the receipt by the processor before processor operates on a received signal. Likewise, the processor may generate one or more output signals, which may be transmitted to an external device, e.g., an external memory or an external system via communication circuitry or, e.g., to one or more a display device. In some embodiments, a signal may be subjected to a time shift in order to delay the signal. For example, a signal may be stored on one or more storage devices to allow for a time shift prior to transmitting the signal to an external device, e.g., the Fraud Detection and Alerting Platform, or one or more intermediate components. One will appreciate that the form of a particular signal will be determined by the particular encoding a signal is subject to at any point in its transmission (e.g., a digital signal stored on a disk or in a memory may have a different encoding than a signal in transit, e.g., on a network, or, e.g., an analog signal will differ in form from a digital version of the signal prior to an A/D conversion.

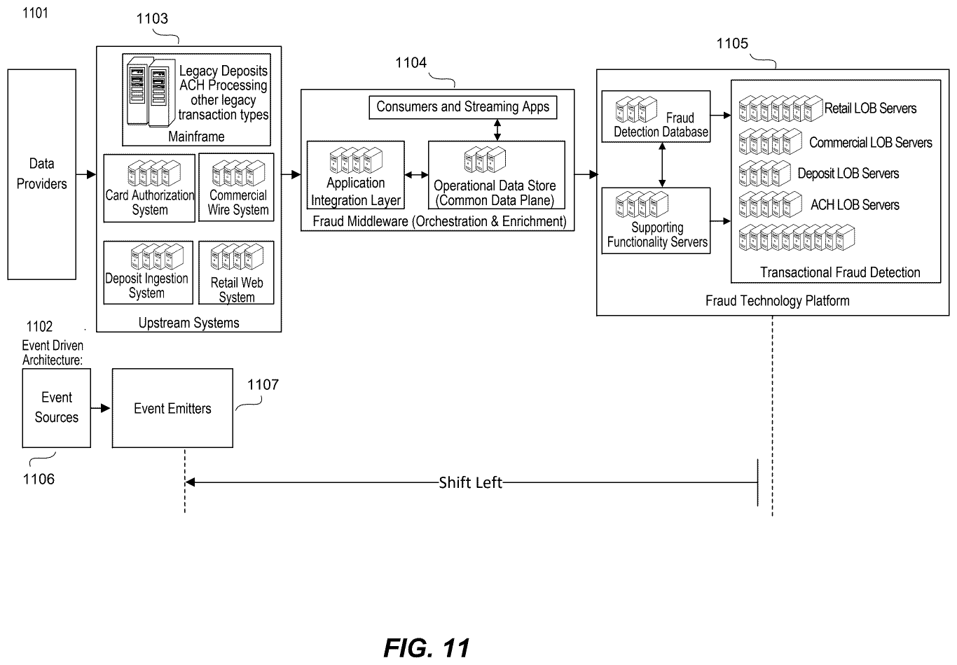

FIG. 11 is a diagram illustrating an exemplary implementation of event driven architecture compared to an exemplary prior art system. FIG. 11 demonstrates the steps a prior art system 1101 needs to go through for services to be integrated with the fraud detection software. As discussed above with reference to FIG. 3, the prior art system includes upstream systems 1103, fraud middleware 1104, and a fraud technology platform 1105. The upstream systems 1103 may include at least one of a mainframe, a card authorization system, a commercial wire system, a deposit ingestion system, or a retail web system. The mainframe may be legacy deposits, Automated Clearing House (ACH) processing, or other legacy transaction types. The middleware 1104 can be software that different applications use to communicate with each other. The middleware 1104 may provide functionality to connect applications intelligently and efficiently. The middleware 1104 may include an application integration layer, an operational data store (common data plane), and consumers and streaming Apps that are in communication with the operational data store. The middleware 1104 may enrich data from mainframe and/or other systems of the upstream systems 1103. The upstream systems 1103 may also send data to the fraud detection platform 1105 through the middleware 1104. The fraud detection platform 1105 may include one or more fraud detection databases, one or more supporting functionality servers, and a transactional fraud detection system. All steps in this process must be carried out before the data from the data providers can be used by the fraud detection software.

Event driven architecture 1102, consistent with some embodiments of the present disclosure, may be an architecture with numerous microservices that each process events. The events are emitted from the event sources 1106, using event emitters 1107. An emitter may be a component or system that generates an event that is of interest to another component or system. An emitting may be the action of publishing or broadcasting the “fact” that an event has occurred. and then are automatically collected by the fraud detection software. The event emitters may publish the event data directly to an event hub, where microservices can analyze the data. Therefore, in some embodiments, all the data providers may need to do is publish and emit the events, at which point integration is complete.

The reduced number of steps and required systems between the event driven architecture 1102 and the prior art system 1101 creates a “shift left” between the prior art system 1101 and the event driven architecture 1102, where the event driven architecture 1101 integrates with the fraud detection software faster and earlier. The earlier integration may lead to faster and more responsive systems that can receive data more quickly. The earlier integration may also be easier for data providers to implement as all they may have to do is publish the events, so software compatibility may be less of a concern.

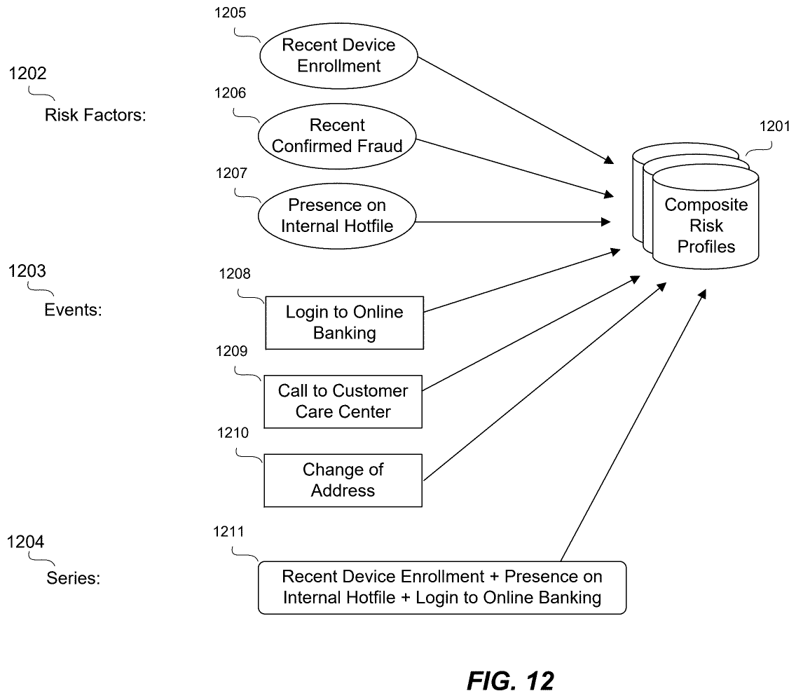

FIG. 12 is a block diagram illustrating some exemplary inputs used in the Composite Risk Profiles 1201 to generate a composite risk score. The Composite Risk Profiles generate a composite risk score based on a number of inputs including risk factors 1202, events 1203, and series of risk factors, events, and other series 1204.

Inputs 1205 through 1207 are exemplary risk factors. For example, input 1205 is a recent device enrollment. If the user has recently enrolled a device to interact with their account, this may create a risk factor. Input 1206 is a recent confirmed fraud. If a fraud involving the user's account has recently been confirmed, this may create a risk factor. Input 1207 is a presence on an internal hotfile. An internal hotfile may track suspicious users or accounts. If the user or account is present on an internal hotfile, this may create a risk factor.

Inputs 1208 through 1210 are exemplary events that may be used to generate risk signals. Based on internal rules, certain events may indicate that a transaction is riskier, or more likely to be fraudulent. In some embodiments, some events may be associated with a risk value, which can influence a generated risk signal. The associated risk values may be updated via machine learning as more data is provided to the system. For example, input 1208 is a login to an online banking system. When a user logs in to an account, this creates an event. Input 1209 is a call to a customer care center. If a user calls a customer care center, this creates an event. Input 1210 is a change of address. If a user updates their recorded address information, this creates an event.

Input 1211 is an exemplary series. Series 1204 may be combinations of risk factors, events, or other series. For example, Input 1211 is a combination of input 1205, recent device enrollment, input 1207, presence on an internal hotfile, and input 1208, login to an online banking system.

The composite risk profiles 1201 store a collection of risk signals for a specified party, account, device, or entity, etc., and act as a central repository of risk signals. The stored risk signals can be provided to machine learning models as inputs to generate additional risk signals. The process of training the machine learning model may include providing a machine learning algorithm with training data to learn from. The training data may be manually selected or automated retrieved from the system storages from historical transactions log and may include risk factors 1202, events 1203, and series 1204. The learning algorithm finds patterns in the training data that map the input data attributes to a target answer, and outputs a machine learning model that captures the patterns. The machine learning model can be any currently available models (e.g., regression, binary classification, multiclass classification, etc.) or future-developed models.

The machine learning model may include a numeric output, such as a value quantifying the level of risk associated with the additional risk signal. For example, a small transaction may be given a low risk value (e.g., 0-25), while a large transaction is given a high risk value (e.g., 75-100). Other properties may have various associated risk values, for example, a deposit may receive a low risk value, while a transfer to a merchant may have a medium risk value, and a transfer to another bank account may have a high risk value. The machine learning model may also include a series output which may include more than one weighted values.

The risk factor inputs included in FIG. 12 are exemplary and non-limiting. In at least some embodiments, risk factors may include a recent risky call, a recent risky login, a recent device enrollment, a recent demographic change, a recent email risk elevation, a recent device risk elevation, a recent confirmed fraud, a recent beneficiary change, a recent high value transaction, a presence on an internal hotfile, and/or a presence on a national shared database.

In at least some embodiments, events may include a login to online banking, a login to mobile banking, a call to an automated interactive voice response system, a call to a customer care center, a change of address, a change of telephone number, a change of email address, an addition of a new authorized account contact, a change in notification or alert preferences, an application for a new account, a closure of an existing account, an addition of a new beneficiary, an addition of a new external account, a new device registration, a mobile carrier change, a mobile carrier disconnect, a device subscriber identity module change, a device unenrollment, a device malware present, a card lock status change, a new contribution to an internal hotfile, and/or a new contribution to a shared database or from a consortium or partner.

The series 1204 may represent any combination of risk factors, events, and other series.

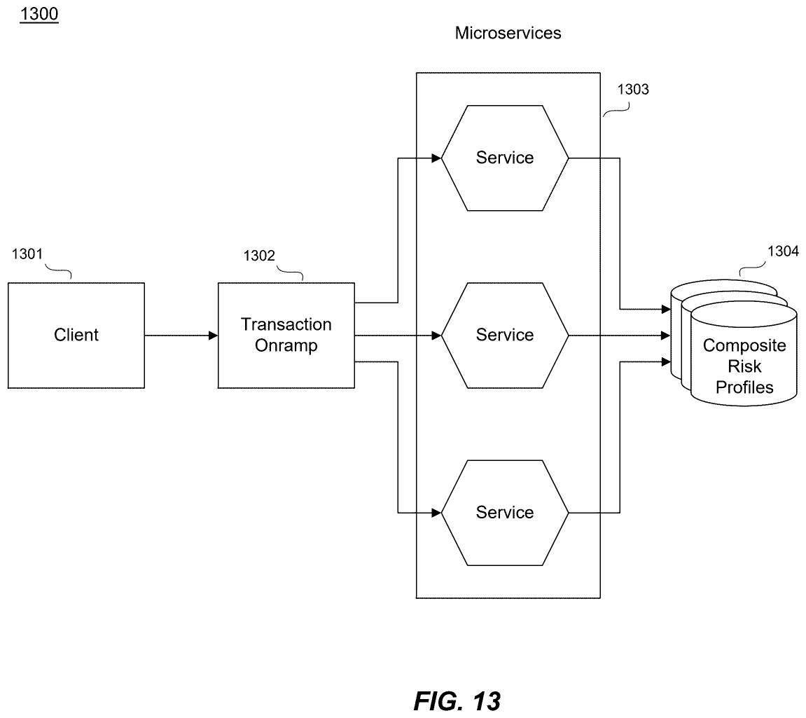

FIG. 13 is a block diagram illustrating a microservice structure 1300, consistent with some embodiments of the present disclosure. A client 1301 publishes event data. Transaction data are received at the transaction onramp 1302, which refers to the entering or delivery of transaction data to the fraud risk analysis platform. The data of the events of interest are collected and emitted to an event hub by an emitter, which may be a component or system that generates an event that is of interest to another component or system. An emitting may be the action of publishing or broadcasting the “fact” that an event has occurred. The events may be collected and stored in an event hub before being transmitted to the microservices 1303 for processing.

Each microservice is a small, independent unit configured to carry out a single task. By creating a chains or stacks of microservices, large amounts of data can be processed. The microservices analyze the event data to determine if composite risk signals need to be updated or triggered. At least one microservice may process the data for one event and then transmit the event data to the composite risk profiles 1304.

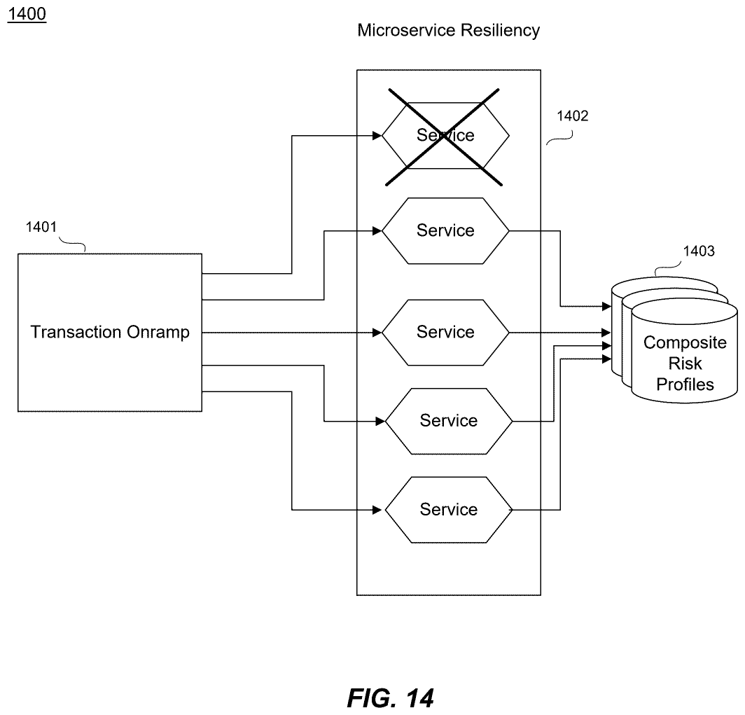

FIG. 14 is a block diagram illustrating the resiliency of a microservice structure 1400. Event data is transmitted from a transaction onramp 1401 to a plurality of microservices 1402, similar to what is described above for FIG. 13. Each microservice process the data for an individual event. The plurality of microservices 1402 then transmit the event data to the composite risk profiles 1403 to generate a composite risk score, similar to what is described above for FIG. 13.

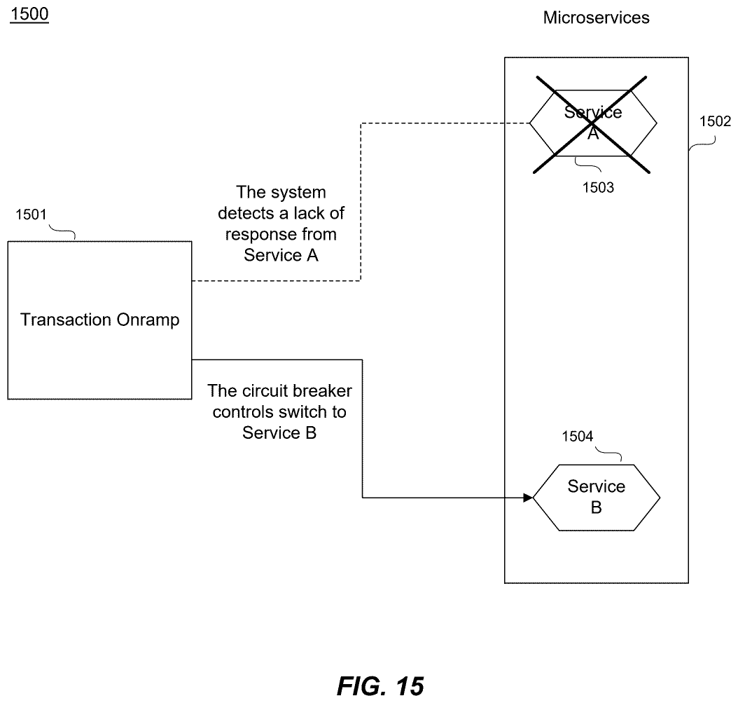

If a microservice fails, as in FIG. 14, the majority of the event data is still processed. Furthermore, in some embodiments if an individual microservice fails that event data may be rerouted through a different microservice, as discussed below with respect to FIG. 15. This structure therefore offers enhanced resiliency over using a single server to process all transactions. When relying on a single server, if the server fails, all data is lost. Thus, the server would be a critical failure point. In the microservice structure 1400, there is no critical failure point that would prevent the transmission of all data.

Additionally, in the case of a failure replacement or repair may be easier and cheaper. Instead of having to replace an entire server, a single microservice could be replaced. Furthermore, the rest of the system could continue operating before the repairs were complete.

FIG. 15 is a block diagram illustrating circuit breaker controls in a system 1500, consistent with some embodiments of the present disclosure. Event data is transmitted from a transaction onramp 1501 to a plurality of microservices 1502. The system attempts to transmit data to a Service A 1503, but the Service A 1503 is unresponsive. The system then cuts off communication with the Service A 1503 and instead transmits the data to a Service B 1504.

In some embodiments, the system may detect that the Service A 1503 is not responding by sending the Service A 1503 a message or communication and receiving no response. In some embodiments, the system may detect that response times from the Service A 1503 are extended by sending the Service A 1503 a message or communication and not receiving a response for longer than some predetermined period of time that would be longer than the typical response time. In some embodiments, when the system detects that the Service A 1503 is unresponsive or that response times are extended, it may produce an alert so that the Service A 1503 can be repaired or replaced.

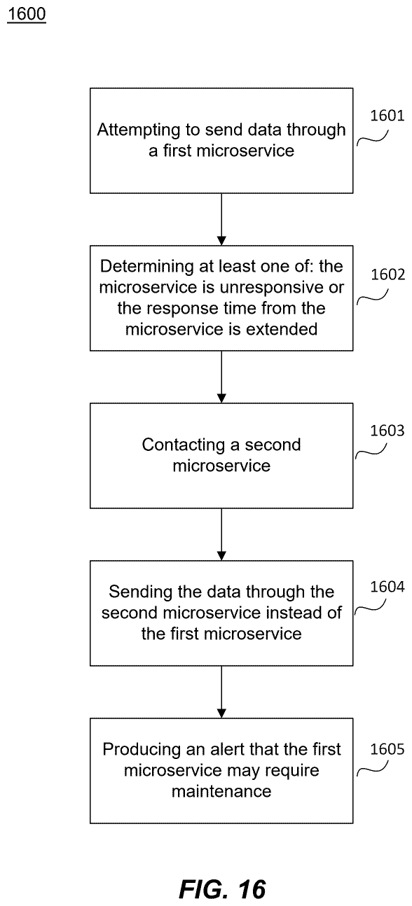

FIG. 16 shows a flowchart of an example method for using circuit breaker controls to reliably send data through the microservices, consistent with some embodiments of the present disclosure. In a step 1601 the method may include attempting to send data through a first microservice. Examples of data may include event data.

In a step 1602 the method may include determining at least one of: the microservice is unresponsive or the response time from the microservice is extended.

In a step 1603 the method may include contacting a second microservice.

In a step 1604 the method may include sending the data through the second microservice instead of the first microservice.

In a step 1605 the method may include producing an alert that the first microservice may require maintenance.

The advantages provided by one or more embodiments of the present disclosure may include, but are not limited to: (1) automation and orchestration-orchestration techniques are used to provide a low-code solution for integration of new data sources, creation of risk signals based on third-party data, and to facilitate better integration with enterprise identity management workflows and user journeys; (2) data autonomy-data from a variety of internal and external sources, along with metadata obtained from multiple repositories, are easily ingestible and used to enrich events; (3) machine learning models-multiple machine learning models are executed in parallel and in isolated execution environments, with model output being provided in real-time as an input signal during event processing; (4) policy management-policy management and distribution are centralized, leveraging industry standard syntax, and are easily exportable; (5) resilience-application components are implemented in a manner that is highly resilient, independently deployable, individually scalable, and performant, while minimizing downtime during planned maintenance and upgrades; (6) minimized impact radius-workloads are isolated to minimize blast radius during disruptive events; (7) adaptive risk profiles-events are continually monitored, collected, stored, and analyzed to generate risk profiles, identify relationships between entities, identify trends, and identify anomalies. Composite risk profiles are generated in near-real-time from continual monitoring and assessment of user, device, account, and party behaviors, and are used when authorizing users and devices for transactions; (8) modern DevOps approach-all application components support modern development practice and CI/CD pipelines. DevOps is a methodology in the software development and IT industry. It emphasizes team empowerment, cross-team communication and collaboration, and technology automation; (9) alert and case management are provided in real-time.

The flowcharts and block diagrams in the figures illustrate examples of the architecture, functionality, and operation of possible implementations of systems, methods, and devices according to various embodiments. It should be noted that, in some alternative implementations, the functions noted in blocks may occur out of the order noted in the figures. For example, two blocks shown in succession may, in fact, be executed substantially concurrently, or the blocks may sometimes be executed in the reverse order, depending upon the functionality involved.

It is understood that the described embodiments are not mutually exclusive, and elements, components, or steps described in connection with one example embodiment may be combined with, or eliminated from, other embodiments in suitable ways to accomplish desired design objectives.

Reference herein to “some embodiments” or “some exemplary embodiments” means that a particular feature, structure, or characteristic described in connection with the embodiment can be included in at least one embodiment. The appearance of the phrases “one embodiment” “some embodiments” or “another embodiment” in various places in the present disclosure do not all necessarily refer to the same embodiment, nor are separate or alternative embodiments necessarily mutually exclusive of other embodiments.

It should be understood that the steps of the example methods set forth herein are not necessarily required to be performed in the order described, and the order of the steps of such methods should be understood to be merely examples. For example, two blocks shown in succession may, in fact, be executed substantially concurrently, or the blocks may sometimes be executed in the reverse order, depending upon the functionality involved. Likewise, additional steps may be included in such methods, and certain steps may be omitted or combined, in methods consistent with various embodiments.

As used in the present disclosure, the word “exemplary” is used herein to mean serving as an example, instance, or illustration. Any aspect or design described herein as “exemplary” is not necessarily to be construed as preferred or advantageous over other aspects or designs. Rather, use of the word is intended to present concepts in a concrete fashion.

As used in the present disclosure, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

Additionally, the articles “a” and “an” as used in the present disclosure and the appended claims should generally be construed to mean “one or more” unless specified otherwise or clear from context to be directed to a singular form.

Although the terms “first,” “second,” etc., may be used herein to describe various elements, these elements should not be limited by these terms. These terms are used to distinguish one element from another. For example, a first element could be termed a second element, and, similarly, a second element could be termed a first element, without departing from the scope of the embodiments.

Although the elements in the following method claims, if any, are recited in a particular sequence, unless the claim recitations otherwise imply a particular sequence for implementing some or all of those elements, those elements are not necessarily intended to be limited to being implemented in that particular sequence.

It is appreciated that certain features of the present disclosure, which are, for clarity, described in the context of separate embodiments, may also be provided in combination in a single embodiment. Conversely, various features of the specification, which are, for brevity, described in the context of a single embodiment, may also be provided separately or in any suitable sub-combination or as suitable in any other described embodiment of the specification. Certain features described in the context of various embodiments are not essential features of those embodiments, unless noted as such.

It will be further understood that various modifications, alternatives and variations in the details, materials, and arrangements of the parts which have been described and illustrated in order to explain the nature of described embodiments may be made by those skilled in the art without departing from the scope. Accordingly, the following claims embrace all such alternatives, modifications and variations that fall within the terms of the claims.

1.-31. (canceled)

32. A computer-implemented method comprising:
collecting event data in an event hub with a plurality of microservices;
interpreting the event data to acquire one or more risk signals by:
processing the event data from at least one microservice of the plurality of microservices; and
identifying the one or more risk signals based on the event data;
transmitting the event data to a composite risk profile, the composite risk profile configured to:
analyze the event data to create one or more risk signals;
compile the one or more risk signals into a single composite risk signal; and
generate a composite risk score based on the event data;
obtaining one or more additional risk signals from a machine learning model by:
obtaining historical transaction data from a historical transaction log;
training the machine learning model using the historical transaction data;
providing the risk signals, the single composite risk signal, and the event data as inputs to the machine learning model; and
receiving the one or more additional risk signals generated by the machine learning model; and
providing the composite risk score, the risk signals, the single composite risk signal, and the one or more additional risk signals to a decision engine, the decision engine configured to:
evaluate the composite risk score using internalized business logic; and
output a decision based on the evaluation of the composite risk score.

33. The method of claim 32, wherein the composite risk profile is further configured to store the one or more risk signals for a specified party, account, device, or entity.

34. The method of claim 33, wherein the composite risk profile is further configured to update the single composite risk signal based on analysis of further event data.

35. The method of claim 32, wherein the event data further includes:
a login to an online banking account,
a login to a mobile banking app,
a call to an automated Interactive voice response system,
a call to a customer care center,
a demographic or account data change,
an account lifecycle event,
a device lifecycle event,
a card lock status change,
a new contribution to a hotfile,
a new contribution to a shared database, or
a new contribution from a consortium.

36. The method of claim 32, wherein the one or more risk signals include at least one of: a recent call, a recent login, a recent device enrollment, a recent demographic change, a recent email risk elevation, a recent device risk elevation, a recent confirmed fraud, a recent beneficiary change, a recent high value transaction, a presence on an internal hotfile, or a presence on a national shared database.

37. The method of claim 32, wherein the decision engine is further configured to determine whether fraud is occurring.

38. The method of claim 32, wherein the historical transaction log includes:
event data,
one or more risk factors,
one or more previous fraud detection determinations, and
third-party data.

39. A system comprising:
one or more processors; and
one or more memories storing instructions that when executed by the one or more processors, cause the system to:
collect event data in an event hub with a plurality of microservices;
interpret the event data to acquire one or more risk signals by:
processing the event data from at least one microservice of the plurality of microservices; and
identifying the one or more risk signals based on the event data;
transmit the event data to a composite risk profile, the composite risk profile configured to:
analyze the event data to create one or more risk signals;
compile the one or more risk signals into a single composite risk signal; and
generate a composite risk score based on the event data;
obtain one or more additional risk signals from a machine learning model by:
obtaining historical transaction data from a historical transaction log;
training the machine learning model using the historical transaction data;
providing the risk signals, the single composite risk signal, and the event data as inputs to the machine learning model; and
receiving the one or more additional risk signals generated by the machine learning model from the machine learning model; and
provide the composite risk score, the risk signals, the single composite risk signal, and the one or more additional risk signals to a decision engine, the decision engine configured to:
evaluate the composite risk score using internalized business logic; and
output a decision based on the evaluation of the composite risk score.

40. The system of claim 39, wherein the composite risk profile is further configured to store the one or more risk signals for a specified party, account, device, or entity.

41. The system of claim 40, wherein the composite risk profile is further configured to update the single composite risk signal based on analysis of further event data.

42. The system of claim 39, wherein the event data further includes:
a login to an online banking account.
a login to a mobile banking app,
a call to an automated Interactive voice response system,
a call to a customer care center,
a demographic or account data change,
an account lifecycle event,
a device lifecycle event,
a card lock status change,
a new contribution to a hotfile,
a new contribution to a shared database, or
a new contribution from a consortium.

43. The system of claim 39, wherein the one or more risk signals include at least one of: a recent call, a recent login, a recent device enrollment, a recent demographic change, a recent email risk elevation, a recent device risk elevation, a recent confirmed fraud, a recent beneficiary change, a recent high value transaction, a presence on an internal hotfile, or a presence on a national shared database.

44. The system of claim 39, wherein the decision engine is further configured to determine whether fraud is occurring.

45. The system of claim 39, wherein the historical transaction log includes:
event data,
one or more risk factors,
one or more previous fraud detection determinations, and
third-party data.

46. A non-transitory computer readable medium storing instructions that, when executed by one or more processors, cause the one or more processors to perform operations comprising:
collecting event data in an event hub with a plurality of microservices;
interpreting the event data to acquire one or more risk signals by:
processing the event data from at least one microservice of the plurality of microservices; and
identifying the one or more risk signals based on the event data;
transmitting the event data to a composite risk profile, the composite risk profile configured to:
analyze the event data to create one or more risk signals;
compile the one or more risk signals into a single composite risk signal; and
generate a composite risk score based on the event data;
obtaining one or more additional risk signals from a machine learning model by:
obtaining historical transaction data from a historical transaction log;
training the machine learning model using the historical transaction data;
providing the risk signals, the single composite risk signal, and the event data as inputs to the machine learning model; and
receiving the one or more additional risk signals generated by the machine learning model from the machine learning model; and
providing the composite risk score, the risk signals, the single composite risk signal, and the one or more additional risk signals to a decision engine, the decision engine configured to:
evaluate the composite risk score using internalized business logic; and
output a decision based on the evaluation of the composite risk score.

47. The non-transitory computer readable medium of claim 46, wherein the composite risk profile is further configured to store one or more risk signals for a specified party, account, device, or entity.

48. The non-transitory computer readable medium of claim 47, wherein the composite risk profile is further configured to update the single composite risk signal based on analysis of further event data.

49. The non-transitory computer readable medium of claim 46, wherein the event data further includes:
a login to an online banking account.
a login to a mobile banking app,
a call to an automated Interactive voice response system,
a call to a customer care center,
a demographic or account data change,
an account lifecycle event,
a device lifecycle event,
a card lock status change,
a new contribution to a hotfile,
a new contribution to a shared database, or
a new contribution from a consortium.

50. The non-transitory computer readable medium of claim 46, wherein the one or more risk signals include at least one of: a recent call, a recent login, a recent device enrollment, a recent demographic change, a recent email risk elevation, a recent device risk elevation, a recent confirmed fraud, a recent beneficiary change, a recent high value transaction, a presence on an internal hotfile, or a presence on a national shared database.

51. The non-transitory computer readable medium of claim 46, wherein the decision engine is further configured to determine whether fraud is occurring.

52. The non-transitory computer readable medium of claim 46, wherein the historical transaction log includes:
event data,
one or more risk factors,
one or more previous fraud detection determinations, and
third-party data.
